(19) United States
(12) Patent Application Publication
(10) Pub. No.: US 2008/0152409 A1
(43) Pub. Date: Jun. 26, 2008

(54) SHEET PROCESSING APPARATUS AND IMAGE FORMING APPARATUS HAVING THE SAME

(75) Inventor: Naoyasu Funada, Matsudo-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Joso-shi (JP)

(21) Appl. No.: 11/959,803

(22) Filed: Dec. 19, 2007

(30) Foreign Application Priority Data
Dec. 25, 2006 (JP) 2006-347447

(51) Int. Cl. G03G 15/00

(52) U.S. Cl. 399/405

(57) ABSTRACT

A sheet processing apparatus that can position a sheet on the front side apart form the back side even if the apparatus is mounted in any opening region of a first image forming apparatus for discharging the sheet into the opening region from right to left and a second image forming apparatus for discharging the sheet into the opening region from left to right. The sheet processing apparatus is mounted in the opening region into which the image forming apparatus discharges the sheet having the image formed by the image forming apparatus. The sheet processing apparatus includes a sheet stacking unit on which the sheet having been discharged into the opening region is stacked; and a position changing unit causing the sheet to position on the front side apart from the back side of the sheet stacking unit based on type information of the image forming apparatus.

### BACKGROUND OF THE INVENTION

1. Field of the Invention

The present invention relates to an image forming apparatus mounted to which a sheet processing apparatus is mounted in an opening region of the image forming apparatus main body, and relates to the sheet processing apparatus that is mounted in the above-mentioned opening region to cause a sheet to be positioned on the front side apart from the back side making it easy for a user to take out the sheet.

2. Related Background Art

In recent years, to save the space of an installation area, an image forming apparatus of such a type as to be formed into a U shape, as viewed from the front, having a left-pointing opening region or into an inverted U shape having a right-pointing opening region in an main body in which a sheet is discharged into the opening region, has been in the mainstream. This type is generally referred to as an in-body sheet discharge type.

The laterally-facing U-shaped (left-opened) image forming apparatus having the left-pointing opening region as viewed from the front is adapted to discharge the sheet into the opening region from right to left. Furthermore, the laterally-facing inverted U-shaped (right-opened) image forming apparatus having the right-pointing opening region as viewed from the front is adapted to discharge the sheet into the opening region from left to right.

Moreover, there may be provided in the opening region of the image forming apparatus a sheet processing apparatus processing the sheet on which an image has been formed (refer to Japanese Patent Application Laid-Open No. 2001-72311). In the sheet processing apparatus, an alignment processing of aligning an edge of the sheet, a stapling processing of stapling a sheet bundle, and the like are conducted.

In the meantime, in the sheet processing apparatus mounted in the opening region of the image forming apparatus of the in-body sheet-discharge type, in general, the space between the sheet having been discharged and the ceiling of the opening region is narrow. Therefore, the sheet having been processed in the sheet processing apparatus to be discharged is hidden by the upper portion of the opening region, thus making it hard for a user to take out the sheet.

To solve such a problem, it is preferred that the sheet be stacked close to the user side (on the front side) apart from the back side. As a result, visibility of the user is improved, thus enabling the user to easily take out the sheet.

If, however, the sheet processing apparatus adapted to stack sheets on the front side apart from the back side in order to be mounted in the opening region of the laterally-facing U-shaped image forming apparatus as viewed from the front is mounted to the opening region of the laterally-facing inverted U-shaped image forming apparatus, the side on which the sheets are stacked is in an opposite direction. Accordingly, in the conventional sheet processing apparatus, the sheet is to be discharged close to the back side. Therefore, depending on the image forming apparatus to which the sheet processing apparatus is mounted, the sheet processing apparatus has a low level of visibility so that it makes it difficult for the user to take out the sheet from the apparatus.

### SUMMARY OF THE INVENTION

The present invention provides a sheet processing apparatus that can position a sheet on the front side apart form the back side even if it is mounted in either an opening region of an image forming apparatus of discharging the sheet in the opening region from right to left or that of an image forming apparatus of discharging the sheet in the opening region from left to right.

The present invention provides an easy-to-handle image forming apparatus provided with a sheet processing apparatus making it easy to take out the sheet.

The present invention provides a sheet processing apparatus to be mounted in an opening region of an image forming apparatus that forms an image on a sheet to discharge the sheet into the opening region of an main body of the image forming apparatus, the sheet processing apparatus comprising: a sheet stacking unit on which the sheet having been discharged in the opening region is stacked; and a position changing unit causing the sheet to position on the front side apart from the back side of the sheet stacking unit based on type information of the image forming apparatus.

The present invention provides an image forming apparatus comprising: an image reading unit reading a document; an image forming unit that is disposed below the image reading unit, and forms an image on a sheet based on image information of the document having been read by the image reading unit; and the above-mentioned sheet processing apparatus mounted in an opening region between the image reading unit and the image forming unit, and stacking the sheet on which the image has been formed by the image forming unit.

The sheet processing apparatus according to the present invention is adapted to position the sheet having been stacked on the sheet stacking unit on the front side apart from the back side by the position changing unit based on type information of the image forming apparatus. As a result, the sheet processing apparatus according to the present invention provides an advantage that a user can easily take out the sheet without visibility being impaired by the upper portion of the opening region of the image forming apparatus in which the sheet processing apparatus is mounted.

The image forming apparatus according to the present invention is provided with the sheet processing apparatus making it easy to take out the sheet, and thus can be an apparatus to be easily handled.

Further features of the present invention will become apparent from the following description of exemplary embodiments with reference to the attached drawings.

### BRIEF DESCRIPTION OF THE DRAWINGS

FIG. 1 is a sectional view taken along a sheet conveying direction of an image forming apparatus according to a first embodiment provided with a sheet processing apparatus according to a first embodiment of the present invention.

FIG. 2 is a schematic plan view of removing a reader portion in the image forming apparatus of FIG. 1.

FIG. 3 is a sectional view taken along a sheet conveying direction of an image forming apparatus according to a second embodiment provided with the sheet processing apparatus according to the first embodiment of the present invention.

FIG. 4 is a schematic plan view of removing a reader portion in the image forming apparatus of FIG. 3.

FIG. 5 is a view corresponding to FIG. 2 in the case where a sheet processing apparatus provided with a sensor of another configuration of detecting the type of an image forming apparatus is mounted in the image forming apparatus according to the first embodiment.

FIG. 6 is a view corresponding to FIG. 4 in the case where a sheet processing apparatus provided with a sensor of another configuration of detecting the type of an image forming apparatus is mounted in the image forming apparatus according to the second embodiment.

FIG. 7 is a schematic sectional view of the sheet processing apparatus according to the first embodiment.

FIG. 8 is a view illustrating the state in which a sheet is discharged on a processing tray of the sheet processing apparatus according to the first embodiment.

FIG. 9 is a view illustrating a driving mechanism of an offset roller and a conveying roller of the sheet processing apparatus according to the first embodiment.

FIGS. 10A and 10B are views, as looking from a downstream toward an upstream in a sheet discharging direction, for illustrating the operation of the offset roller and the movement of a sheet in association with the operation when a sheet bundle is stapled by a first stapler unit in the sheet processing apparatus according to the first embodiment mounted in the image forming apparatus according to the first embodiment.

FIGS. 11A and 11B are views illustrating the operation following the operation of FIG. 10B.

FIGS. 12A and 12B are views illustrating the operation following the operation of FIG. 11B.

FIGS. 13A and 13B are views, as looking from a downstream toward an upstream in a sheet discharge direction, for illustrating the operation of the offset roller and the movement of a sheet in association with the operation when a sheet bundle is stapled by a second stapler unit in the sheet processing apparatus according to the first embodiment mounted in the image forming apparatus according to the second embodiment.

FIGS. 14A and 14B are views for illustrating the operation following the operation of FIG. 13B.

FIG. 15 is a control block diagram of the sheet processing apparatus according to the first embodiment.

FIG. 16 is a sectional view taken along a sheet conveying direction of the image forming apparatus according to the first embodiment provided with a sheet processing apparatus according to a second embodiment of the present invention.

FIG. 17 is a schematic plan view of removing a reader portion in the image forming apparatus of FIG. 16.

FIG. 18 is a sectional view taken along a sheet conveying direction of the image forming apparatus according to the second embodiment provided with the sheet processing apparatus according to the second embodiment of the present invention.

FIG. 19 is a schematic plan view of removing a reader portion in the image forming apparatus of FIG. 18.

FIG. 20 is a view illustrating the construction of the sheet processing apparatus according to the second embodiment.

FIG. 21 is a view illustrating the state in which a sheet is discharged on a processing tray of the sheet processing apparatus according to the second embodiment.

FIG. 22 is a view illustrating a driving mechanism of an offset roller and a conveying roller of the sheet processing apparatus according to the second embodiment.

FIGS. 23A and 23B are views, as looking from a downstream toward an upstream in a sheet discharge direction, for illustrating the operation of the offset roller and the movement of a sheet in association with the operation in the sheet processing apparatus according to the second embodiment mounted in the image forming apparatus according to the first embodiment.

FIGS. 24A, 24B and 24C are views, as looking from a downstream to an upstream in a sheet discharge direction, for illustrating the operation of the offset roller and the movement of a sheet in association with the operation in the sheet processing apparatus according to the second embodiment mounted in the image forming apparatus according to the second embodiment.

FIGS. 25A and 25B are views illustrating the operation following the operation of FIG. 24C.

FIGS. 26A and 26B are views illustrating a driving mechanism of a sheet bundle discharge member of the sheet processing apparatus according to the second embodiment.

FIG. 27 is a view illustrating the state in which the sheet bundle discharge member according to the second embodiment discharges a sheet bundle on a stack tray.

FIG. 28 is a view illustrating a driving mechanism of a sheet clamp member of the sheet processing apparatus according to the second embodiment.

FIGS. 29A and 29B are views illustrating a driving mechanism of a holding-down member of the sheet processing apparatus according to the second embodiment.

FIG. 30 is a control block diagram of the sheet processing apparatus according to the second embodiment.

FIG. 31 is a flowchart for illustrating the operation when the sheet processing apparatus according to the second embodiment is mounted in the image forming apparatus according to the first embodiment.

FIG. 32 is a flowchart following FIG. 31.

FIG. 33 is a flowchart for illustrating the operation when the sheet processing apparatus according to the second embodiment is mounted in the image forming apparatus according to the second embodiment.

FIG. 34 is a flowchart following FIG. 33.

### DESCRIPTION OF THE EMBODIMENTS

Hereinafter, sheet processing apparatuses according to a first embodiment and a second embodiment of the present invention, and image forming apparatuses according to a first embodiment and a second embodiment on which the sheet processing apparatuses according to the first embodiment and the second embodiment are mountable will be described with reference to the accompanying drawings.

(Image Forming Apparatus)

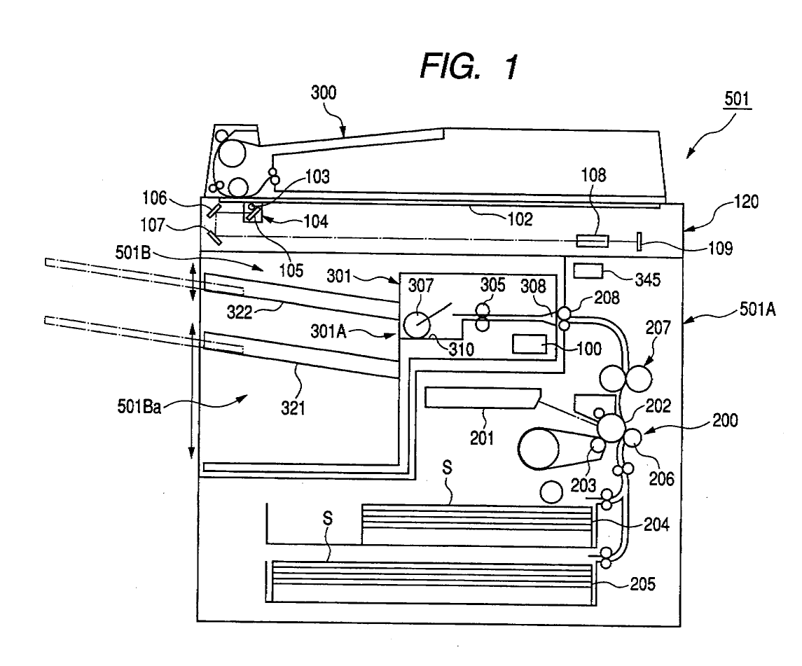

An image forming apparatus 501 according to the first embodiment (FIGS. 1, 2, 16 and 17) provided with a left-pointing opening region 501B in a main body 501A, and is formed in the shape of a laterally-facing U (left-opened) as viewed from the front. This image forming apparatus 501 is adapted to discharge a sheet into the opening region 501B from right to left. In the opening region 501B, sheet processing apparatuses 301 and 400 (FIGS. 1, 2, 16 and 17) according to the first embodiment and the second embodiment can be selectively mounted.

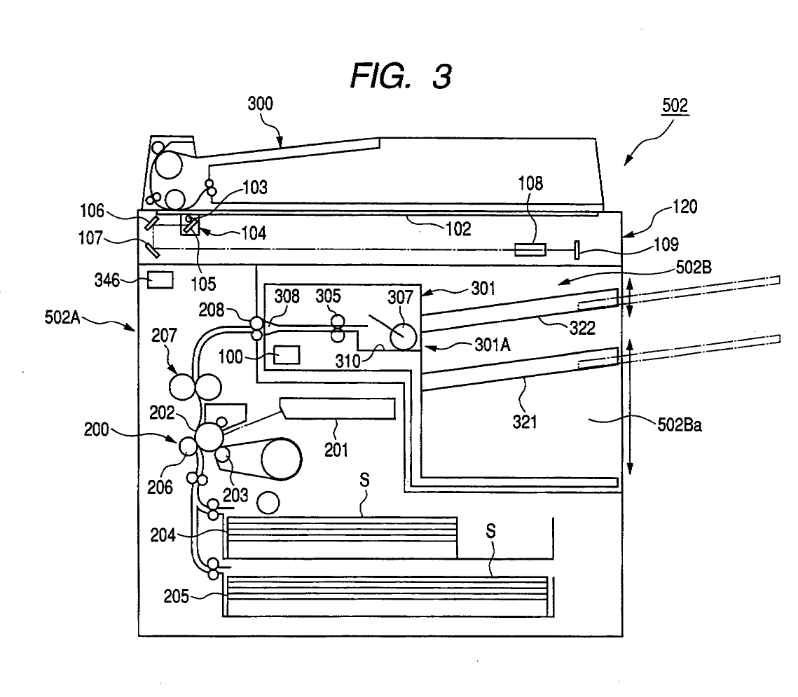

An image forming apparatus 502 according to the second embodiment (FIGS. 3, 4, 18 and 19) provided with a right-pointing opening region 502B in a main body 502A, and is formed in the shape of a laterally-facing inverted U (right-opened) as viewed from the front. This image forming apparatus 502 is adapted to discharge the sheet into the opening region 502B from left to right. In the opening region 502B, the sheet processing apparatuses 301 and 400 according to the first embodiment and the second embodiment (FIGS. 3, 4, 18 and 19) can be selectively mounted.

The sheet processing apparatuses 301 and 400 according to the first embodiment and the second embodiment can be mounted in an image forming apparatus as an option.

(Image Forming Apparatus According to the First Embodiment)

FIG. 1 is a sectional view taken along a sheet conveying direction of an image forming apparatus according to the first embodiment provided with a sheet processing apparatus according to the first embodiment of the present invention.

In an upper portion of a main body 501A of an image forming apparatus 501, an image reading unit such as a reader portion 120 and an automatic document feeding apparatus (ADF) 300 are stacked in order on top of one another. The reader portion 120 reads an image of a document to convert it to image data. The automatic document feeding apparatus (ADF) 300 automatically feeds the document to the reader portion 120. The reader portion 120 can read the document placed on a platen glass 102, so that the automatic document feeding apparatus 300 is not necessarily provided.

The opening region 501B is defined by the main body 501A and the reader portion 120. On the back side of the opening region 501B, there is formed a wall 501Ba to reinforce the main body 501A. The sheet processing apparatus 301 according to the first embodiment is mounted in the opening region 501B.

In the image forming apparatus 501, in the case where an image of a document is read and this image is formed on a sheet, first the documents (not illustrated) stacked on the automatic document feeding apparatus 300 are conveyed onto the surface of the platen glass 102 of the reader portion 120 sequentially one by one.

Next, when the document is conveyed to a predetermined position of being scanned on the platen glass 102, a scanner unit 104 having a lamp 103 is moved and stopped in the position shown in FIG. 1, and the document is irradiated with the lamp 103. A reflected light from the document is input to a CCD image sensor portion 109 through mirrors 105, 106 and 107 and a lens 108. At this CCD image sensor portion 109, an electric processing such as a photoelectric conversion is conducted to undergo a normal digital processing.

For example, a printer portion 200, being an image forming unit includes sheet cassettes 204 and 205 on which plural types of sheets are stacked, and functions to form a visualized toner image on a sheet based on image data by a print instruction.

The image signal having been subjected to the above-mentioned electric processing is converted into a modulated optical signal at an exposure control portion 201 at the printer portion 200 in the main body 501A, and the optical signal irradiates a photosensitive drum 202. Then, the irradiated light forms a latent image on the photosensitive drum 202. This latent image is developed with a toner by a developing device 203 to be a toner image.

Subsequently, at a timing synchronized with a leading edge of this toner image coming, a sheet is fed to between the photosensitive drum 202 and a transfer portion 206, and the toner image is transferred onto a sheet S by the transfer portion 206. The toner image having been transferred onto the sheet S is fixed by a fixing portion 207. Finally, the sheet S is fed to the sheet processing apparatus 301 from a sheet discharge portion 208.

The image forming apparatus 501 according to the first embodiment, although described later, due to the provision of the sheet processing apparatuses 301 and 400 according to the first embodiment and the second embodiment (FIGS. 1, 2, 16 and 17), is constructed so as to position a sheet on the front side where the sheet can be easily taken out, thus to be an apparatus making it easy to handle the sheet.

(Image Forming Apparatus According to the Second Embodiment)

FIG. 3 is a sectional view taken along a sheet conveying direction of an image forming apparatus according to the second embodiment provided with the sheet processing apparatus according to the first embodiment of the present invention.

An image forming apparatus 502 according to the second embodiment (FIGS. 3, 4, 18 and 19) is provided with a right-pointing opening region 502B in a main body 502A, and is formed into the shape of the laterally-facing inverted U (right-opened) as viewed from the front. This image forming apparatus 502 is adapted to discharge a sheet into the opening region 502B from left to right. In the opening region 502B, the sheet processing apparatuses 301 and 400 (FIGS. 3, 4, 18 and 19) according to the first embodiment and the second embodiment can be selectively mounted.

The image forming apparatus 502 according to this embodiment has a structure in which the image forming apparatus 501 according to the first embodiment is changed to be right-pointed, so that like portions are designated with like reference numerals, to omit descriptions of the structure. Incidentally, a wall 502Ba to reinforce the opening region 502B is formed on the back side.

The image forming apparatus 502 according to the second embodiment, although described later, due to the provision of the processing apparatuses 301 and 400 (FIGS. 3, 4, 18 and 19) according to the first embodiment and the second embodiment, is adapted to position a sheet on the front side where the sheet can be easily taken out, thus to be an apparatus making it easy to handle the sheet.

(Sheet Processing Apparatus According to the First Embodiment)

The sheet processing apparatus 301 according to the first embodiment is arranged to be selectively mounted in the image forming apparatuses 501 and 502 (FIGS. 1 to 4) according to the first embodiment and the second embodiment.

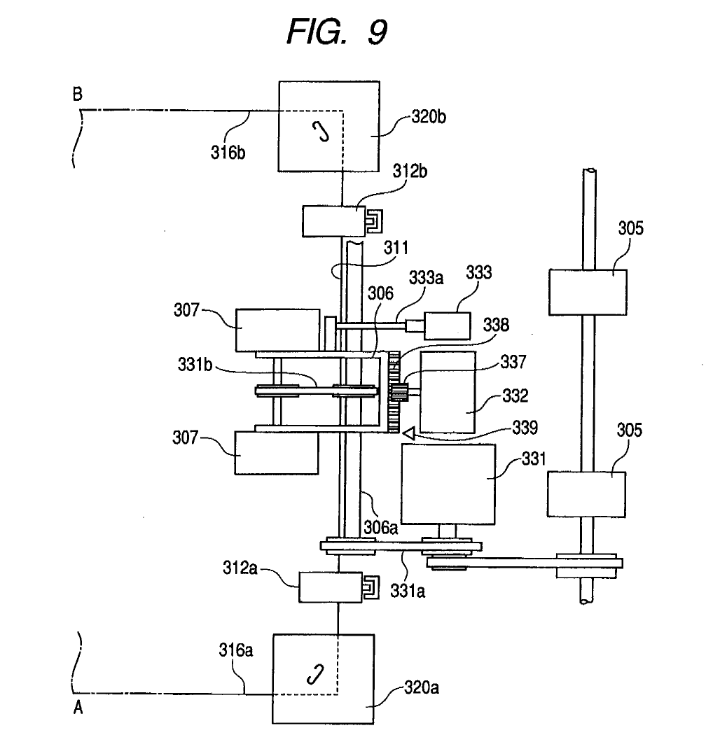

The sheet processing apparatus 301, as illustrated in FIGS. 1 and 3, is arranged to be contained in the opening region 501B, 502B that is formed in the main body 501A, 502A of the image forming apparatus without protruding from the main body 501A, 502A. Furthermore, the sheet processing apparatus 301 possesses a sorting function to sort sheets, as well as a stapling function to staple a sheet bundle by stapler units 320a and 320b illustrated in FIG. 9.

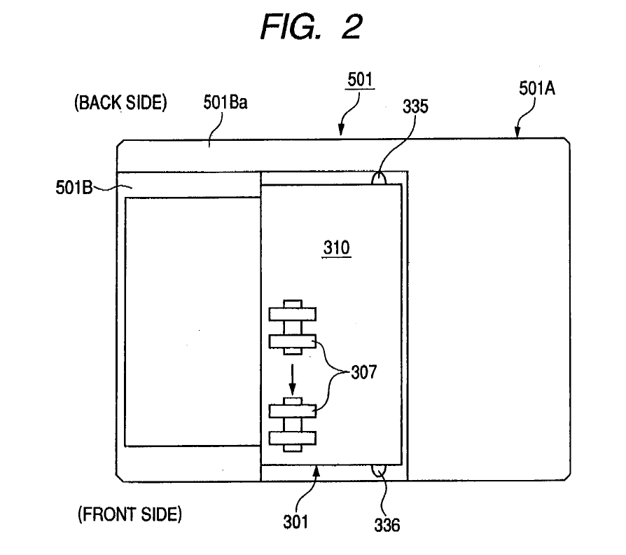

In the sheet processing apparatus 301, as illustrated in FIGS. 2 and 4, there are provided on both sides along the sheet conveying direction of the main body 301A left-pointing and right-pointing detecting sensors 335 and 336 detecting whether the image forming apparatus in which the sheet processing apparatus 301 is mounted is an image forming apparatus of discharging a sheet to the left or an image forming apparatus of discharging the sheet to the right.

In the sheet processing apparatus 301, as illustrated in FIGS. 1 and 2, in the case of being provided in the image forming apparatus 501 of discharging a sheet from right to left, the left-pointing detecting sensor 335 detects the wall 501Ba on the back side of the opening region 501B. Thus, the below-described CPU 100 makes a control so that an offset roller 307 is moved to the front side. Therefore, the sheet having been discharged onto a processing tray 310 is moved to the front side by the offset roller 307, thus making it easy for a user to take out the sheet.

This sheet processing apparatus 301, as illustrated in FIGS. 3 and 4, in the case of being provided in the image forming apparatus 502 of discharging the sheet from left to right, different from the case of being mounted in the image forming apparatus 501 according to the first embodiment, is faced in an inverted direction. In the sheet processing apparatus 301, however, the right-pointing detecting sensor 336 detects the wall 502Ba on the back side in the opening region 502B, so that the below-described CPU 100 controls the offset roller 307 to move the sheet to the front side. With the arrangement, the sheet having been discharged onto the processing tray 310 is moved to the front side by the offset roller 307, thus making it easy for a user to take out the sheet.

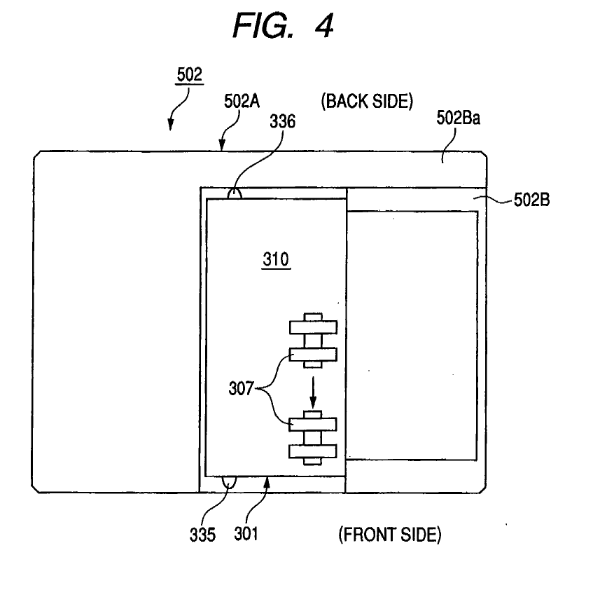

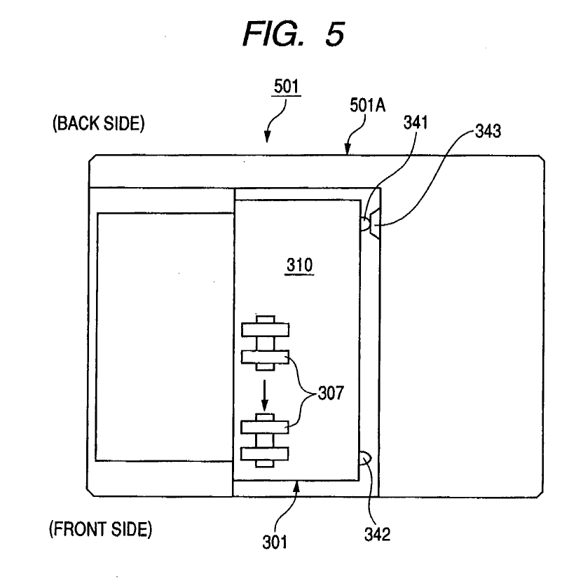

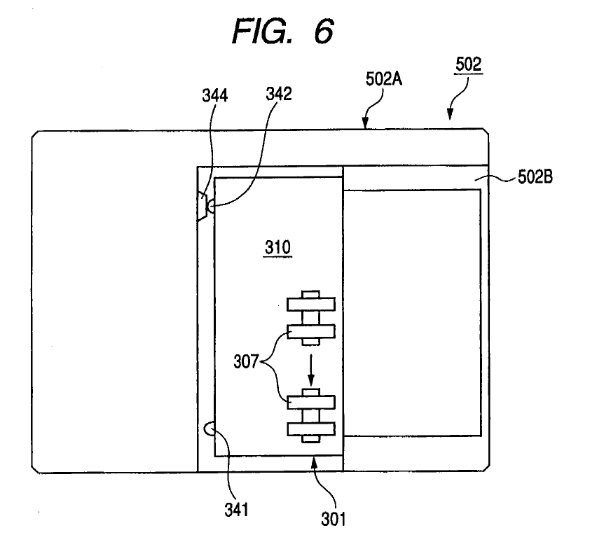

To discriminate the type of an image forming apparatus in which the sheet processing apparatus 301 is mounted, with the use of left-pointing and right-pointing detecting sensors 341 and 342 provided at the sheet processing apparatus 301 (FIGS. 5 and 6), a protrusion 343, 344 of the main body 501A, 502A of the image forming apparatus may be detected for discrimination. Incidentally, a concave portion may be used instead of the protrusion.

In addition, the type of an image forming apparatus may be discriminated by the CPU 100 (FIGS. 1, 3 and 15) of the sheet processing apparatus 301 receiving type information from a notifying unit such as a control portion 345, 346 (FIGS. 1 and 3) provided in the main body 501A, 502A of the image forming apparatus.

In the above descriptions, the left-pointing and right-pointing detecting sensors 335, 336, 341 and 342, the protrusions 343 and 344, and the like are one example of a discrimination unit.

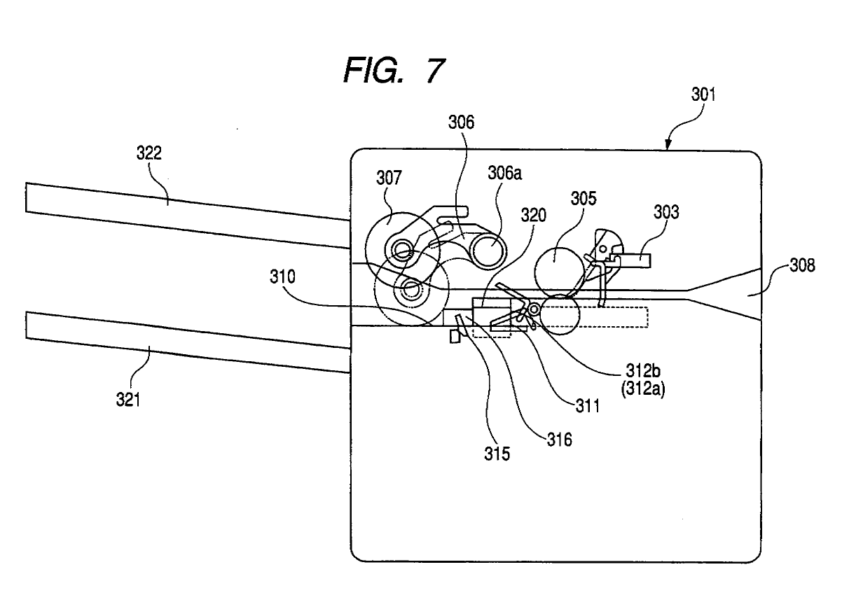

The sheet processing apparatus 301 (FIG. 7) is mainly provided with a processing tray 310 processing a sheet S to be sequentially discharged from the main body 501A, 502A of the image forming apparatus, and a stack tray 321, 322 on which a sheet bundle having been processed on the processing tray 310 are finally stacked. In the sheet processing apparatus 301, a sheet bundle of the number of sheets corresponding to the number of documents is formed on the processing tray, to be discharged onto the stack tray 321, 322 for each sheet bundle.

In FIG. 7, a sheet receiving portion 308 is a portion of receiving the sheet S having been discharged from the main body 501A, 502A. The sheet S having been received at this sheet receiving portion 308 is detected by an inlet sensor 303 and thereafter conveyed by a conveying roller 305 that is driven by a conveying motor 331 (FIG. 9) and an offset roller 307 to rotate in synchronization with the conveying roller 305. Thereafter, the sheet is discharged onto a sheet stacking unit such as the processing tray 310. Incidentally, the sheet S that is stacked on the processing tray 310 in such a way is to be detected by a sheet bundle discharge sensor 315 (FIG. 7).

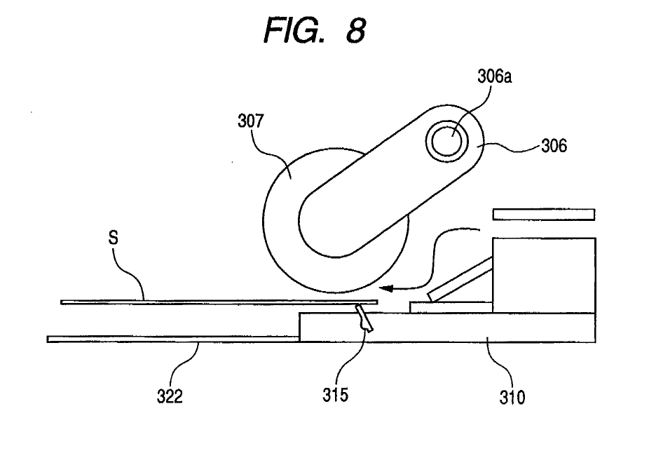

The offset roller 307 is held so as to be capable of being lifted or lowered by an offset roller arm 306 that can be vertically moved about a shaft 306a shown in FIGS. 7 to 10B. The offset roller 307, when the sheet S is discharged onto the processing tray 310, is moved upward by the offset roller arm 306, not to hamper the discharge of the sheet S.

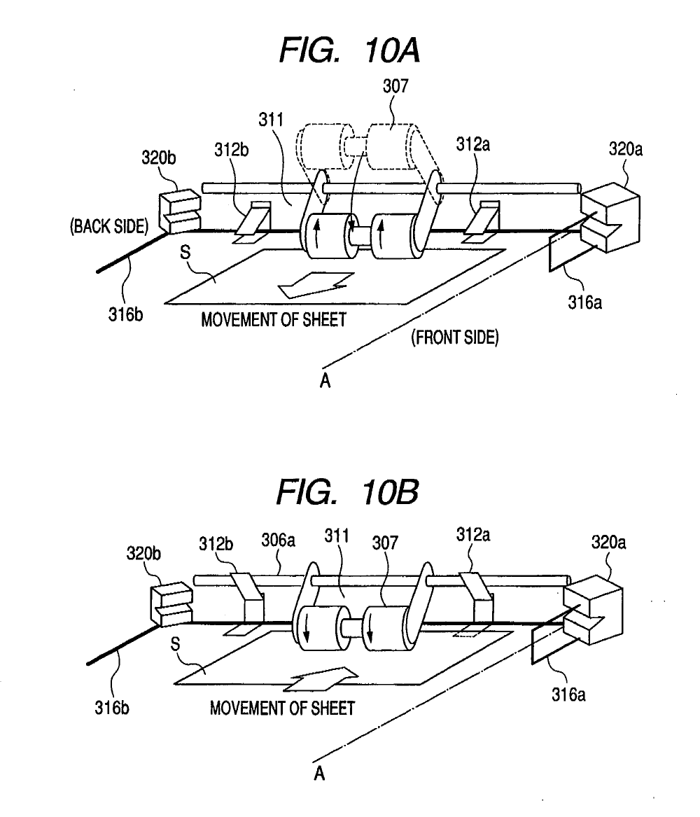

The offset roller arm 306 is adapted to be lifted and lowered with the shaft 306a as a fulcrum via a down lever 333a by a pickup solenoid 333 (FIG. 9). That is, the offset roller 307 is adapted to be lifted and lowered upon ON and OFF of this pickup solenoid 333 (FIG. 10A).

The offset roller 307 (FIG. 9), when the conveying motor 331 to drive the conveying roller 305 is rotated, is brought into rotation (reverse rotation) in the conveying direction or in the opposite direction by the amount corresponding to the rotation amount of the conveying motor through belts 331a and 331b (FIGS. 10A and 10B). The offset roller 307 (FIG. 9) is adapted to be rotated along with the conveying roller 305.

Incidentally, the sheet processing apparatus according to this embodiment is arranged such that the sheet S is detected by the inlet sensor 303 to be conveyed by the conveying roller 305, and when being conveyed to a predetermined position where the trailing edge of the sheet S has not passed the conveying roller 305 yet, the pickup solenoid 333 is turned off. Whereby, the offset roller 307 is lowered under its own weight to be landed on the sheet, rotated in the sheet conveying direction for a predetermined time period, and thereafter reversely rotated.

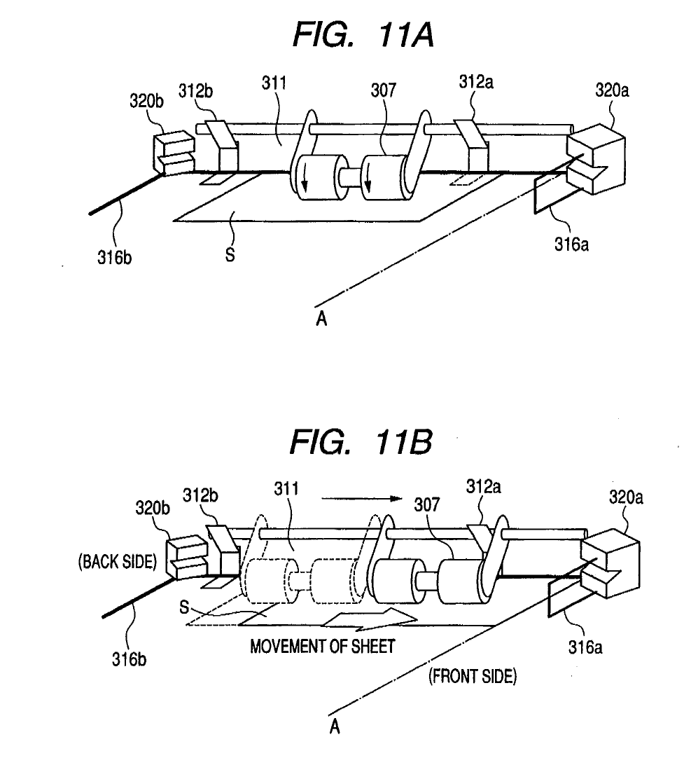

With the arrangement, the offset roller 307, by the reverse rotation, causes the trailing edge of the sheet to abut on a sheet trailing edge stopper 311 that is erected at the end of the processing tray 310 on the upstream side in the conveying direction to make an alignment in the conveying direction of the sheet S (FIGS. 10B and 11A).

Incidentally, in FIG. 9, a first positioning wall 316a receives a side edge of the sheet having been moved in the direction (hereinafter referred to as a width direction) orthogonal with respect to the sheet conveying direction by the offset roller 307, to make an alignment. The operation of the offset roller 307 moving the sheet in the width direction will be described later. A first stapler unit 320a is disposed close to the first positioning wall 316a to staple a sheet bundle having been positioned by the first positioning wall 316a.

Moreover, a second positioning wall 316b receives the side edge of the sheet having been moved in the width direction by the offset roller 307, to make an alignment. The operation of the offset roller 307 moving the sheet in the width direction will be described later. A second stapler unit 320b is disposed close to the second positioning wall 316b to staple a sheet bundle having been positioned by the second positioning wall 316b.

Therefore, the first positioning wall 316a and the second positioning wall 316b make an alignment of the side edges of the sheet on the opposite sides to each other. Further, the second stapler unit 320b and the first stapler unit 320a staple portions in the vicinity of corners of the opposite sides of the sheet bundle. Incidentally, the first and the second positioning walls 316a and 316b and the first and the second stapler units 320a and 320b are not necessarily provided.

Furthermore, the offset roller 307 (FIG. 9) is moved in the width direction of the sheet by the forward rotation or the reverse rotation of the offset motor 332 through a pinion 337 and a rack 338, to be capable of selectively moving to the first or the second positioning wall side. The pinion 337 is provided on the rotary shaft of the offset motor 332. The rack 338 is provided integrally with the offset roller arm 306. The length of the rack 338 is not limited to the length shown in FIG. 9, and is to be set according to the distance of moving the offset roller arm 306 and the offset roller 307. The offset roller 307 takes the center in the width direction of the sheet conveying path as a home position, which is detected by an offset home position sensor 339.

The offset roller 307 and the offset motor 332 are one example of a position-changing unit.

The offset roller 307, while moving to the first positioning wall 316a, causes the sheet having been abutted on the sheet trailing edge stopper 311 to be aligned in the conveying direction to move to the first positioning wall 316a by a frictional force provided by the offset roller 307 to be abutted (FIGS. 11A and 11B). The sheet having been abutted on the first positioning wall 316a is aligned at the side edge (FIG. 11B). Incidentally, the offset roller 307, after having caused the side edge of the sheet S to abut on the first positioning wall 316a, is moved while being slid on the sheet to be stopped. Whereby, the sheet is reliably contacted with the first positioning wall 316a, and in the case of being skew-fed, the skew feed is corrected.

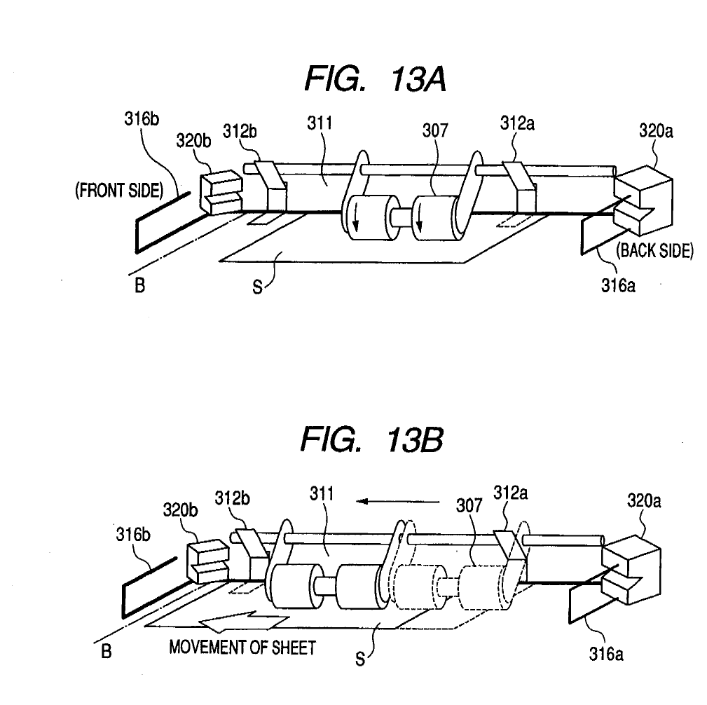

The offset roller 307, also in the case of abutting the sheet on the second positioning wall 316b to make an alignment of the side edge of this sheet, makes the same operation (FIGS. 13A and 13B).

Incidentally, while the offset roller 307 shown in FIG. 7 is disposed on the outside of the offset roller arm 306, the offset roller 307 shown in the below-described FIGS. 10A to 14B is disposed on the inside of a pair of the offset roller arms 306. These constructions are different merely in design, and there is no difference in function and action.

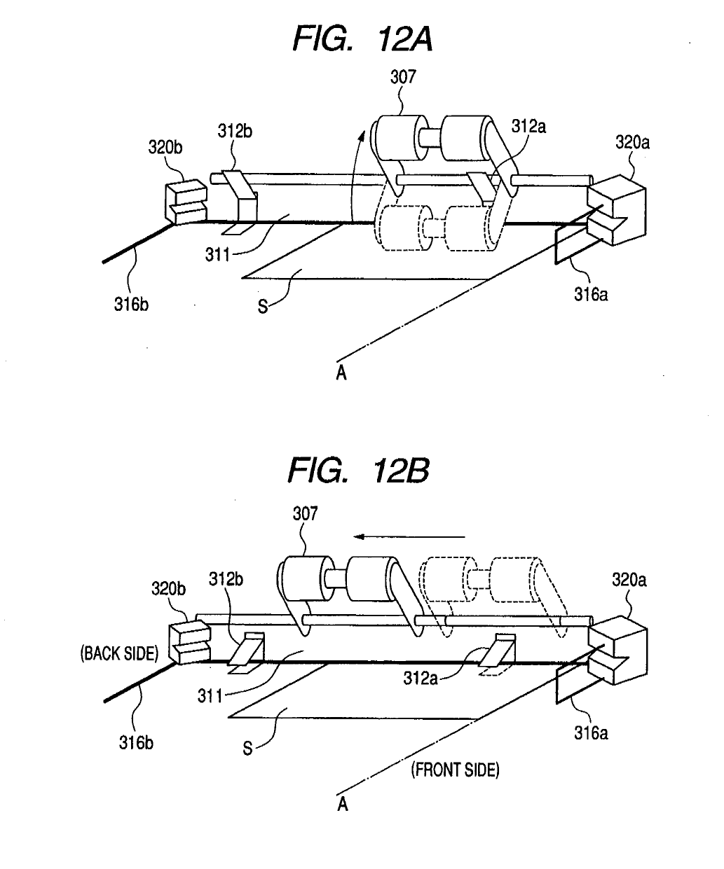

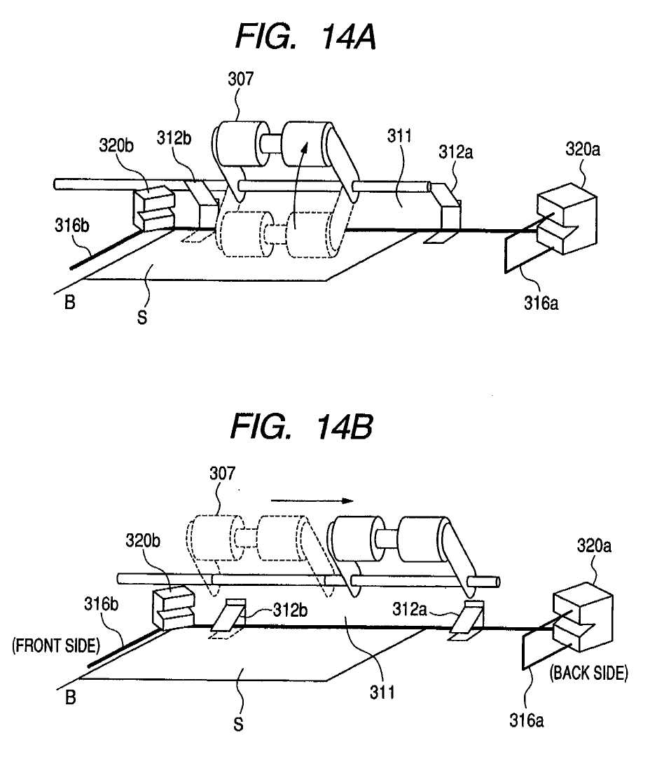

Incidentally, in FIG. 9, a first and a second gripper claws 312a and 312b are adapted to pinch the trailing edge portion of the aligned sheet S by a biasing member (not shown). The first and the second gripper claws 312a and 312b are adapted to hold the sheet S after the offset roller 307 has made an alignment of the sheet in order of the trailing edge, the side edge, and the trailing edge again of the sheet to be lifted as shown in FIGS. 12A and 14A.

With the arrangement, the sheet S having been previously discharged onto the processing tray 310 can be held in a predetermined position without being affected by the feed occurring associated with the subsequent sheets S sequentially fed. Incidentally, in the case of FIG. 12B, only the first gripper claw 312a of the first and the second gripper claws 312a and 312b holds the sheet S. In addition, in the case of FIG. 14B, only the second gripper claw 312b of the first and the second gripper claws 312a and 312b holds the sheet S. In addition, in FIGS. 12B and 14B, when the width of the sheet is the width that can be held by both of the first and the second gripper claws 312a and 312b, the sheet may be held by both of the claws 312a and 312b.

Furthermore, the gripper claws 312a and 312b, when the offset roller 307 is reversely rotated, are adapted to be pivoted upward (opened) as shown in FIGS. 10B and 13A so as to be capable of receiving the sheet S. In addition, the gripper claws 312a and 312b, also when the offset roller 307 and the sheet S are moved in the width direction for the purpose of the alignment of an edge, are adapted to be pivoted upward (opened) as shown in FIGS. 11B and 13B so as not to become the load against the movement of the sheet S.

Incidentally, after the offset roller 307 moves the sheet S in the width direction to make a width alignment of the sheet, the offset roller 307 is reversely rotated again to align an upstream edge of the sheet to correct the misalignment of the sheets in the sheet conveying direction, and the alignment processing is completed. At this time, when the alignment processing of a specified number of sheets has completed, the gripper claws 312a and 312b are closed to hold the sheet bundle. With the arrangement, the sheet processing apparatus can make a high-level alignment of the sheet bundle.

The first and the second gripper claws 312a and 312b hold the sheet bundle having been aligned or the sheet bundle having been stapled, move toward the stack tray 321 that is provided on the downstream side of the processing tray 310, discharge the sheet bundle onto the stack tray 321, and finally return to the original position.

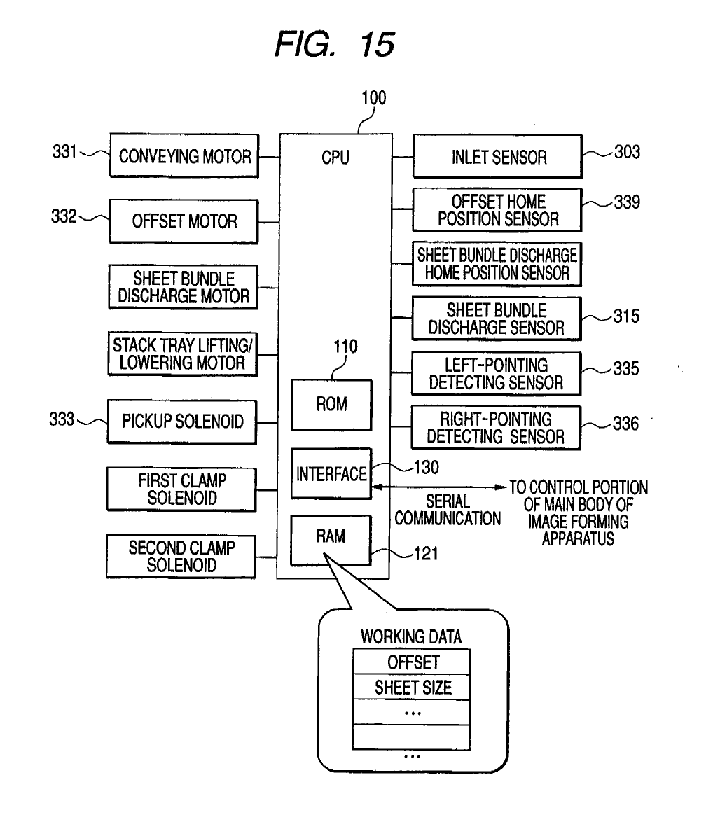

FIG. 15 is a block diagram illustrating the configuration of a control portion of the sheet processing apparatus 301 as described above. The CPU 100 includes a ROM 110 inside, and makes a control of each element while reading out a control program stored in the ROM 110.

In addition, the CPU 100 contains therein a RAM 121 in which a working data and an input data are stored, and the CPU 100 makes a control of each portion based on the data stored in the RAM 121. To an input port of the CPU 100, sensors such as an inlet sensor 303 are connected. The CPU 100 reads out the program stored in the ROM 110 based on the state of these sensors, and executes the program to control the load of the conveying motor 331 that is connected to an output port.

The CPU 100 makes a transmission and reception of control data with a control portion 345, 346 of the main body 501A, 502A via a serial interface portion (I/O) 130, as well as makes a control of each element based on the control data from the control portion 345, 346.

In FIGS. 15, 1 and 2, when the left-pointing detecting sensor 335 detects the main body 501A of the image forming apparatus, the CPU 100 controls the rotation direction of the offset motor 332 (FIG. 9) to move the offset roller 307 to the first positioning wall 316a side. Whereby, the sheet on the processing tray 310 is moved to the front side, thus making it easy for a user to take out the sheet.

Likewise, in FIGS. 15, 3 and 4, when the right-pointing detecting sensor 336 detects the main body 502A of the image forming apparatus, the CPU 100 controls the rotation direction of the offset motor (FIG. 9) to move the offset roller 307 to the second positioning wall 316b side. Whereby, the sheet on the processing tray 310 is moved to the front side, thus making it easy for a user to take out the sheet.

Incidentally, also in the case where there are provided the left-pointing and the right-pointing detecting sensors 341 and 342 (FIGS. 5 and 6) instead of the left-pointing and the right-pointing detecting sensors 335 and 336 (FIGS. 2 and 4), the CPU 100 makes the similar control.

Furthermore, the CPU 100 may receive type information of an image forming apparatus from the control portion 345, 346 (FIGS. 1 and 3) of the image forming apparatus and controls the rotation direction of the offset motor 332 (FIG. 9) based on this type information, to move the sheet to the front side.

The above-described sheet processing apparatus 301 is arranged such that the offset roller 307 positions the sheet stacked on the processing tray 310 to the front side apart from the back side based on a detecting operation of the left-pointing and the right-pointing detecting sensors 335 and 336 (FIGS. 2 and 4). Therefore, depending on whether the apparatus in which the sheet processing apparatus 301 is mounted is the image forming apparatus 501 according to the first embodiment or the image forming apparatus 502 according to the second embodiment, the sheet can be positioned on the front side apart from the back side. Thus, in the sheet processing apparatus 301, a user can easily take out the sheet without visibility being impaired by the upper portion of the opening region 501B, 502B of the image forming apparatus onto to be mounted.

Moreover, the image forming apparatus 501, 502 provided with the above sheet processing apparatus 301, due to that the sheet processing apparatus 301 is arranged to make it easy to take out the sheet, can be an apparatus that can be easily handled.

(Sheet Processing Apparatus According to the Second Embodiment)

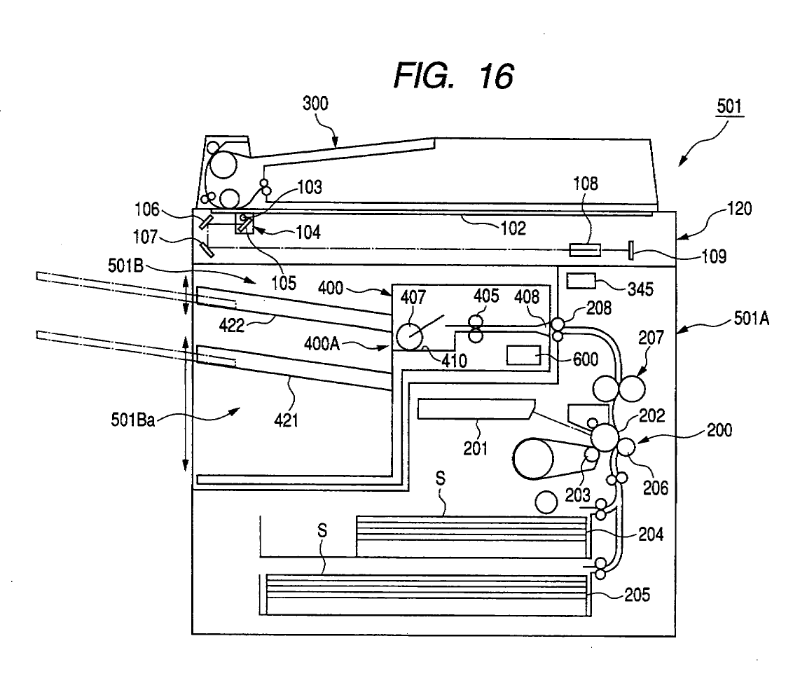

The sheet processing apparatus 400 according to the second embodiment is adapted to be selectively mounted in the image forming apparatuses 501 and 502 (FIGS. 16 to 19) according to the first embodiment and the second embodiment as well.

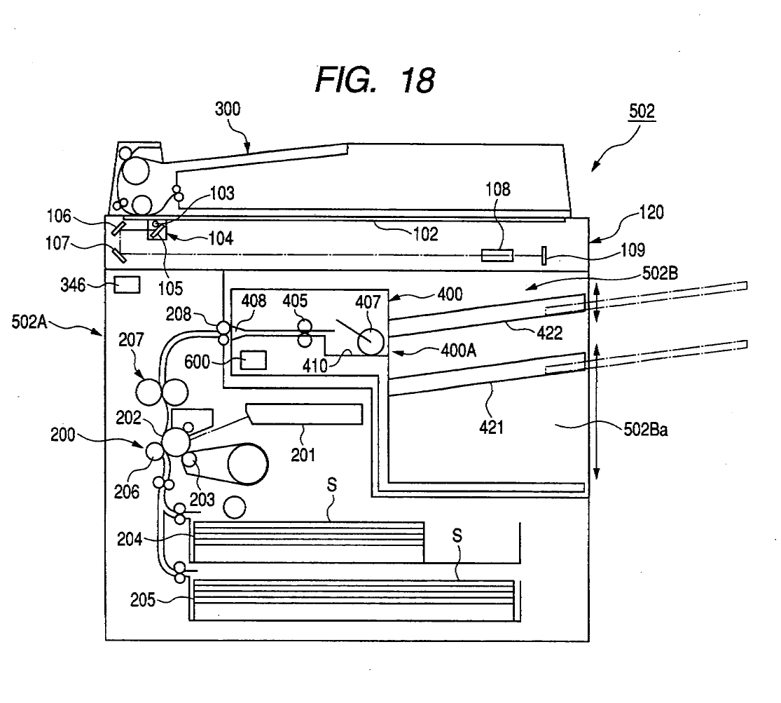

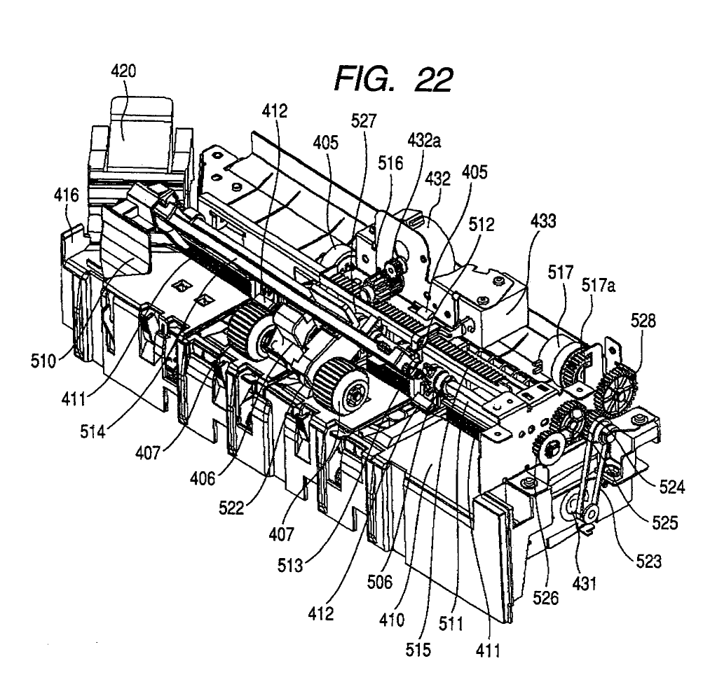

The sheet processing apparatus 400, as illustrated in FIGS. 16 and 18, is adapted to be contained in the opening region 501B, 502B formed in the main body 501A, 502A of the image forming apparatuses without protruding from the main body 501A, 502A. Furthermore, the sheet processing apparatus 400 possesses a sorting function to sort sheets, as well as a stapling function to staple a sheet bundle by a stapler unit 420 shown in FIG. 22.

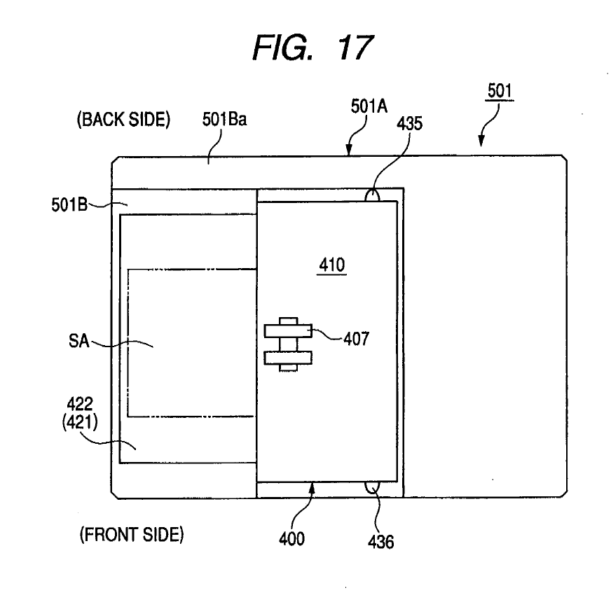

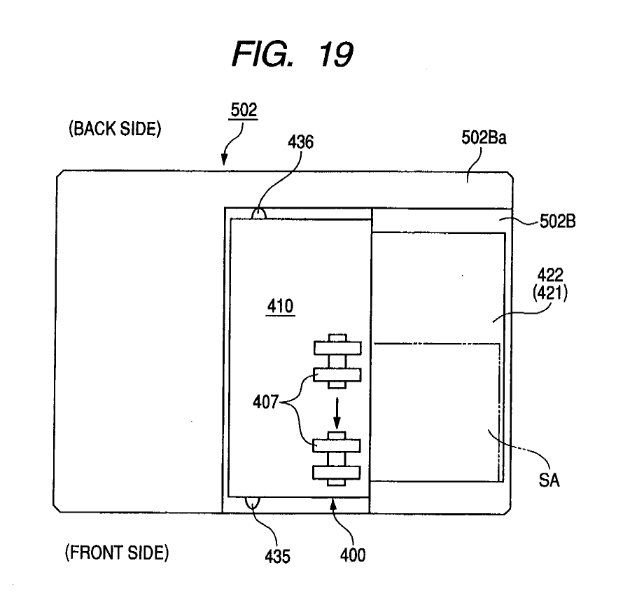

In the sheet processing apparatus 400, as illustrated in FIGS. 17 and 19, there are provided on both sides along the sheet conveying direction of the main body 400A left-pointing and right-pointing detecting sensors 435 and 436. The left-pointing and the right-pointing detecting sensors 435 and 436 are adapted to detect whether an image forming apparatus in which the sheet processing apparatus 400 is mounted is an image forming apparatus of discharging the sheet to the left or an image forming apparatus of discharging the sheet to the right.

In the sheet processing apparatus 400, as illustrated in FIGS. 16 and 17, in the case of being provided in the image forming apparatus 501 of discharging a sheet from right to left, the left-pointing detecting sensor 435 detects the wall 501Ba on the back side of the opening region 501B. Thus, a CPU 600 as described below makes a control so that an offset roller 407 is moved to the front side apart from the back side. With the arrangement, the sheet having been discharged onto a processing tray 410 is moved to the front side apart from the back side by the offset roller 407, thus making it easy for a user to take out the sheet.

This sheet processing apparatus 400, as illustrated in FIGS. 18 and 19, in the case of being provided in the image forming apparatus 502 of discharging the sheet from left to right, unlike the case of being mounted in the image forming apparatus 501 according to the first embodiment, is directed in an opposite direction. In the sheet processing apparatus 400, however, the right-pointing detecting sensor 436 detects the wall 502Ba on the back side in the opening region 502B, so that the below-described CPU 600 controls the offset roller 407 to move the sheet to the front side apart from the back side. With the arrangement, the sheet having been discharged onto the processing tray 410 is moved to the front side by the offset roller 407, thus making it easy for a user to take out the sheet.

To discriminate the type of an image forming apparatus in which the sheet processing apparatus 400 is mounted, as illustrated in FIGS. 5 and 6, with the use of the left-pointing and the right-pointing detecting sensors 341 and 342, the protrusion 343, 344 of the main body 501A, 502A of the image forming apparatus may be detected and discriminated. Incidentally, a concave portion may be used instead of the protrusion.

In addition, the type of an image forming apparatus may be discriminated by receiving at the CPU 600 (FIGS. 16, 18 and 30) of the sheet processing apparatus 400 type information from the control portion 345, 346 (FIGS. 16 and 18) as an indicating unit provided at the main body 501A, 502A of the image forming apparatus.

In the above descriptions, the left-pointing and the right-pointing detecting sensors 435, 436, 341 and 342, the protrusions 343 and 344 and the like are one example of a discrimination unit.

The sheet processing apparatus 400 (FIG. 16) is mainly provided with a processing tray 410 processing a sheet S to be sequentially discharged from the main body 501A, 502A of the image forming apparatus, and a stack tray 421, 422 on which a sheet bundle having been processed on the processing tray 410 is finally stacked. The sheet processing apparatus 400 is constructed and controlled such that a sheet bundle of the number of sheets corresponding to the number of documents is formed on the processing tray, to be discharged and stacked on a stack tray (lower bin) 421 or a stack tray (upper bin) 422 for each sheet bundle.

Here, the sheet processing apparatus 400 may be so constructed and controlled on the conditions that plural numbers (two in this embodiment) of stack trays 421 and 422 can be lifted or lowered independently.

In FIG. 20, a sheet receiving portion 408 is a portion of receiving a sheet S having been discharged from the main body 501A, 502A of the image forming apparatus. The sheet S having been received at the sheet receiving portion 408 is detected by an inlet sensor 403 and thereafter conveyed by a conveying roller 405 driven by a conveying motor 431 (FIG. 22) and an offset roller 407 to rotate in synchronism with the rotation of the conveying roller 405. Thereafter, the sheet is discharged onto the processing tray 410 as a sheet stacking unit provided at a sheet processing portion 400B serving to process the sheet. Incidentally, the sheet S stacked on the processing tray 410 in such a way is detected by a sheet bundle discharge sensor 415 (FIG. 20).

The offset roller 407 is an elastic body having elasticity close to that of rubber such as a rubber or a foam at the outer circumferential portion of a cylindrical member. This offset roller 407 is held by an offset roller holder 406 that can be lifted or lowered about an offset shaft 511 shown in FIG. 22.

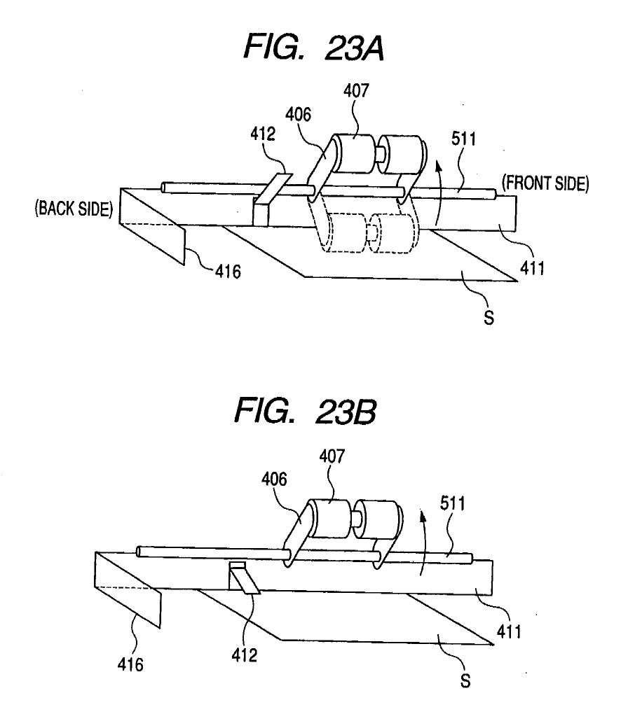

The offset roller holder 406 shown in FIG. 22 can be lifted or lowered with the offset shaft 511 a fulcrum by a pickup solenoid 433. That is, the offset roller 407 is adapted to be lifted or lowered via a solenoid arm 512, a lever holder 513, a spaced lever 514, and an offset roller holder 406 when this pickup solenoid 433 is turned on or off (FIG. 23A).

The offset roller 407, when the sheet S is discharged onto the processing tray 410, is lifted to its upper position of not preventing the conveyance of the sheet S (FIG. 23A). The offset roller 407 is moved to its upper position via the solenoid arm 512, the lever holder 513, the spaced lever 514 and the offset roller holder 406 when the pickup solenoid 433 is turned on. Whereby, the sheet S is conveyed onto the processing tray 410 without being impaired by the offset roller 407.

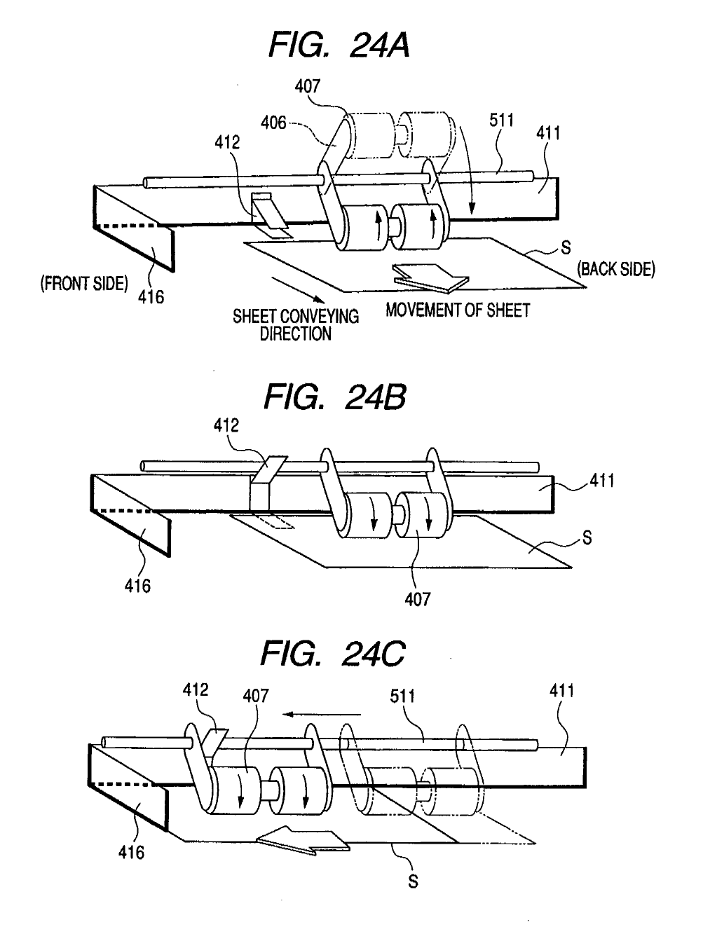

The offset roller 407 (FIG. 22) is adapted to rotate via a timing belt 523, a roller gear 524, an idler gear 525, an offset gear 526, an offset pulley 527 and a timing belt 522 by the conveying motor 431 that can forward and reverse rotate. The conveying motor 431 causes the conveying roller 405 to rotate as well. The offset roller 407, when the conveying motor 431 is rotated, is adapted to rotate in the conveying direction (forward rotation) or to rotate in the direction opposite to the conveying direction (hereinafter referred to as reverse rotation) by the amount corresponding to the rotation amount of the conveying motor 431 (FIGS. 24A and 24B).

Incidentally, the sheet processing apparatus according to this embodiment is arranged such that the sheet S is detected by the inlet sensor 403 to be conveyed by the conveying roller 405, and when being conveyed to a predetermined position where the trailing edge of the sheet S has not passed the conveying roller 405 yet, the pickup solenoid 433 is turned off. Whereby, the offset roller 407 is lowered with the aid of its own weight while rotating in the sheet conveying direction to be landed (contacted) on the sheet, conveys the sheet in a predetermined time period, and thereafter when a further predetermined time period has elapsed, is brought into reverse rotation,

With the arrangement, the offset roller 407, by the reverse rotation, causes the trailing edge of the sheet to abut on the sheet trailing edge stopper 411 that is erected vertically at the end on the upstream side in the conveying direction of the processing tray 410 to make an alignment in the conveying direction of the sheet S (FIG. 24B).

Incidentally, in FIG. 22, a positioning wall 416 receives a side edge of the sheet having been moved in the direction orthogonal with respect to the sheet conveying direction (hereinafter referred to as a width direction) by the offset roller 407, to make an alignment. The operation of the offset roller 407 moving the sheet in the width direction will be described later. A stapler unit 420 is disposed in the vicinity of the positioning wall 416 of the processing tray 410 to staple a sheet bundle having been positioned by the positioning wall 416. The offset roller 407 is moved in the width direction via an offset motor gear 432a, and an offset pinion 516 and an offset rack 515 by the forward rotation or the reverse rotation of the offset motor 432, to be close to the positioning wall 416. The length of the offset rack 515 is not limited to the length shown in FIG. 22, but is set according to the distance of moving the offset roller holder 406 and the offset roller 407.

The offset roller 407 and the offset motor 432 are one example of a position changing unit.

The offset roller 407, while being moved to the positioning wall 416, causes the sheet having been abutted on the sheet trailing edge stopper 411 to be aligned in the conveying direction to move to the positioning wall 416 by a frictional force provided by the offset roller 407 to be contacted. At this time, the sheet, while entering under a sheet-pressing part 510 (FIG. 22) to correct a curl thereof, is contacted with the positioning wall 416 at the side edge of the sheet along the sheet conveying direction to be positioned. Incidentally, the offset roller 407, after having abutted the sheet S on the positioning wall 416, is moved a predetermined amount toward the positioning wall 416 while being slid on the sheet to be stopped. Whereby, the sheet is reliably contacted with the positioning wall 416, and in the case of being skew-fed, the skew feed is corrected.

The sheet having been discharged onto the processing tray 410, as shown in FIG. 24A, is conveyed to the stack tray 421, 422 (FIGS. 16 and 18) side by the offset roller 407 in rotation in the sheet conveying direction. Thereafter, the sheet, as shown in FIG. 24B, is returned to the sheet trailing edge stopper 411 by the reverse rotation of the offset roller 407, and thereafter abutted on the trailing edge stopper 411 at the trailing edge to be aligned.

Incidentally, while the offset roller 407 shown in FIG. 22 is disposed on the outside of the offset roller holder 406, the offset roller 407 shown in the below-described FIGS. 23A to 25B is disposed on the inside of a pair of the offset roller holders 406. These constructions are different merely in design, and there is no difference in function and action.

Furthermore, the offset roller 407 (FIG. 24C) is moved to the positioning wall 416 side along the offset shaft 511 in the state of being contacted with the sheet S, and presses the end of the sheet S in the width direction (side edge) against the positioning wall 416 to make an alignment in the width direction of the sheet S.

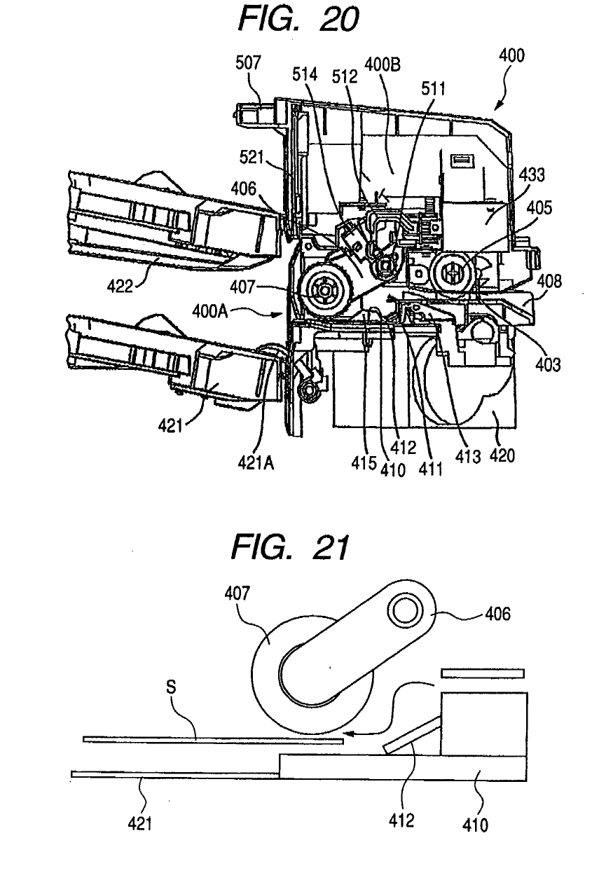

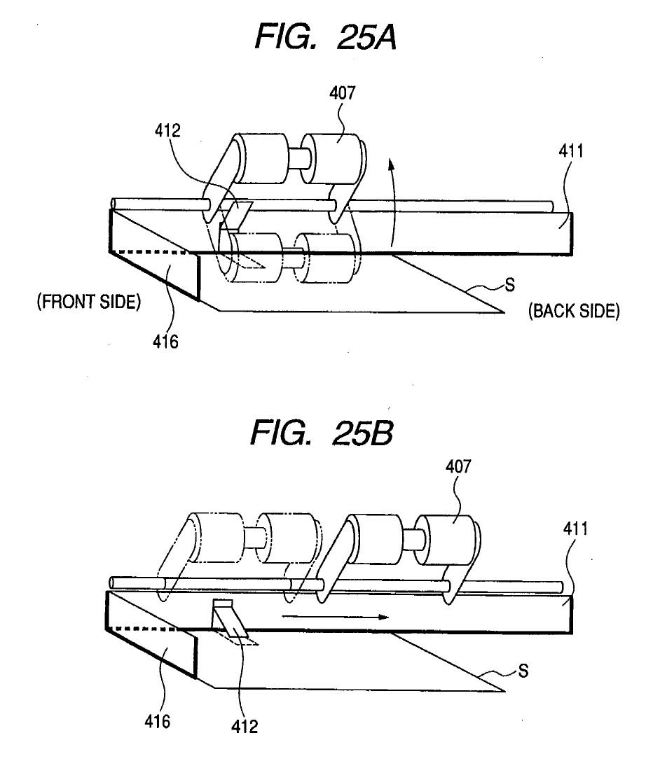

Incidentally, in FIGS. 21, 22, 23A, 23B, 25A and 25B, a sheet clamp member 412 is arranged to pinch the trailing edge portion of the sheet S having been aligned by a biasing member not illustrated. The sheet clamp member 412 (FIGS. 24A, 24B, 24C, 25A and 25B) holds the sheet S having been aligned when the offset roller 407, as described later, has made a trailing-edge alignment, a width alignment, and the trailing-edge alignment again of the sheet S in order, and is separated from this sheet.

Due to that the sheet clamp member 412 holds the sheet S, the sheet S having been previously discharged (conveyed) onto the processing tray 410 is held in a predetermined position without being fed in association with the feed of a subsequent sheet to be fed thereafter,

In addition, the sheet clamp member 412, when the offset roller 407 is in reverse rotation, is opened as shown in FIG. 24B so as to be capable of receiving the sheet S. Furthermore, the sheet clamp member 412, when the sheet S is moved in the width direction along with the offset roller 407, is opened as shown in FIG. 24C so as not to be the load against the movement of the sheet S.

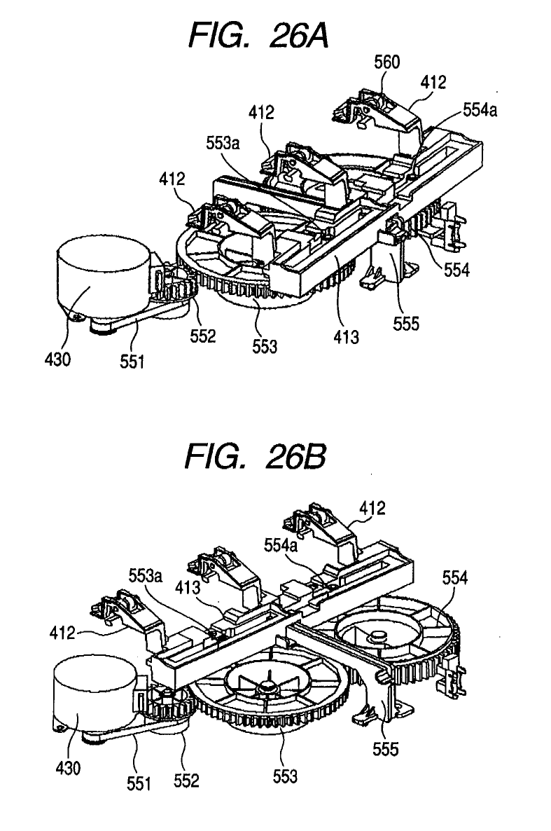

Moreover, in FIG. 26, a sheet bundle discharge member 413 causes the sheet clamp member 412 that is pivotally held to hold a sheet bundle having been aligned or stapled to move it to the stack tray (lower bin or upper bin) 421, 422.

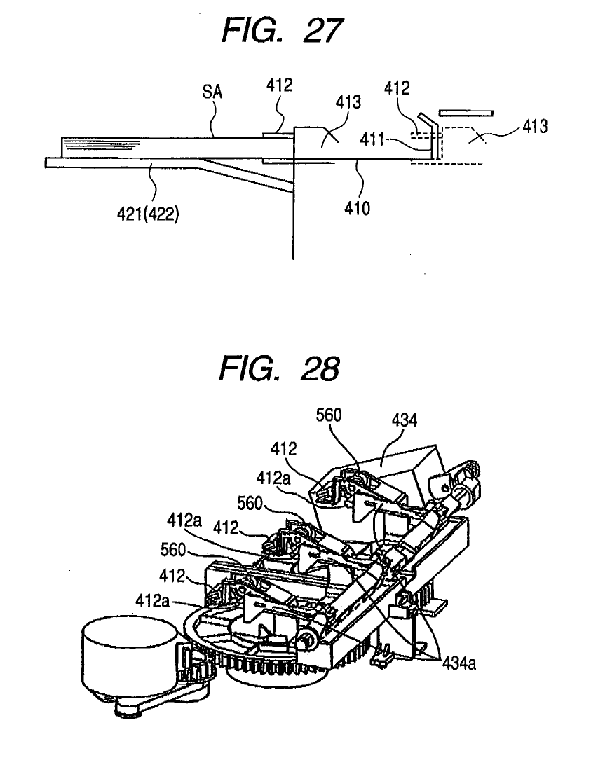

The sheet bundle discharge member 413 (FIG. 27), when a sheet bundle SA is conveyed to the leading end of the processing tray 410, being a sheet discharge position, is stopped on the stack tray 421, 422, releases the sheet bundle SA from being held by the sheet clamp member 412, and then returned to the trailing edge stopper 411 side.

With the arrangement, in the sheet processing apparatus 400, by the discharge operation of a sheet bundle of the sheet bundle discharge member 413, unlike the conventional art, the sheet bundle can be stacked on the stack tray with stability in a limited space at a small inclined angle (about nine degrees) without the stack tray being inclined about 30 degrees.

Incidentally, the sheet bundle having been discharged and stacked onto the stack tray 421, 422 in such a way is adapted to be held down against the stack tray by a holding-down member 421A shown in FIG. 20. With the arrangement, due to that the sheet bundle SA is held down against the stack tray by the holding-down member 421A, the reduction of a stacking performance owing to the curl of the sheet, the misalignment of a preceded sheet bundle having been stacked already following the subsequent sheet bundle, and the like can be prevented. As a result, as described above, at a small inclined angle (about nine degrees) of the stack tray, the sheet bundle can be discharged and stacked onto the stack tray with stability in a limited space.

Here, a slide gear A 553 and a slide gear B 554 to rotate via a belt 551 and a pulley gear 552 by driving of the sheet bundle discharge motor 430 shown in FIGS. 26A and 26B are vertically provided with a pin A 553a and a pin B 554a. By the pin A 553a and the pin B 554a moving in a guide slit (not illustrated) that is formed in the sheet bundle discharge member 413 while rotating integrally with the slide gear A 553 and the slide gear B 554, the sheet bundle discharge member 413 moves.

The sheet bundle discharge member 413, by the sheet bundle discharge motor 430, is adapted to reciprocate in a slide rail 555 between the position of discharging the sheet onto the stack tray 421, 422 (FIG. 26B) and a home position in the vicinity of the trailing edge stopper 411 (FIG. 26A).

Incidentally, this sheet bundle discharge member 413 is normally held in the home position by the excitation of the sheet bundle discharge motor 430.

In FIG. 28, a clamp solenoid 434 is to pivot (open or close) the sheet clamp member 412. The clamp solenoid 434 is turned on when the offset roller 407 has conveyed the sheet, and thereafter stops rotation, and when the offset roller 407 is moved in the width direction. Whereby, the clamp solenoid 434 causes the sheet clamp member 412 to pivot upward (open) via a lever 434a and a release lever portion 412a that is provided at the sheet clamp member 412.

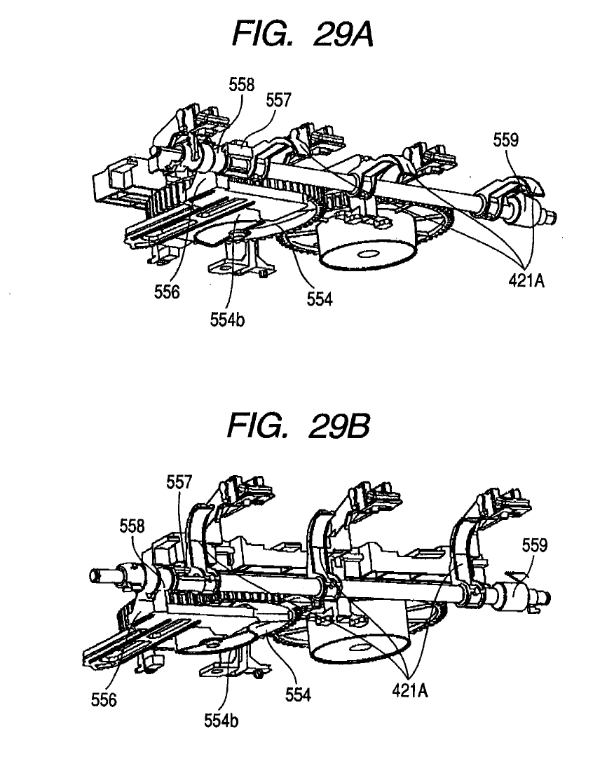

Incidentally, the holding-down member 421A, as shown in FIG. 29A, is transmitted with a power via a press member 556, a lever member 557 and a coil spring 558 by a cam B 554b that is disposed at the lower portion of the slide gear B 554 to be pivoted. In addition, this holding-down member 421A, in the case where the power is not transmitted, as shown in FIG. 29B, by a return coil spring 559, is positioned in the state of being retracted with respect to a stack surface of the sheet on the stack tray 421, 422.

When the slide gear A 553 and the slide gear B 554 are rotated by the sheet bundle discharge motor 430, the sheet bundle discharge member 413 discharges the sheet bundle onto the stack tray 421, 422. Thereafter, the cam B 554b is released from pressing the press member 556. Thus, the holding-down member 421A, by the return coil spring 559, comes to be in the state in which the sheet bundle can drop on the stack tray 421, 422 with respect to the stack surface of the sheet.

Furthermore, thereafter, the sheet bundle is dropped on the stack tray 421, 422, and before the sheet bundle discharge member 413 is returned to the trailing edge stopper 411, the cam B 554b at the lower portion of the slide gear B 554 operates the press member 556. The press member 556 causes the holding-down member 421A to pivot via a lever member 557 and a coil spring 558, and thus the sheet bundle is held by the holding-down member 412A.

In the meantime, in this embodiment, after the sheet S has been moved in the width direction as described above, to correct the misalignment in the sheet conveying direction, the offset roller 407 is brought into reverse rotation again, to end an alignment operation. With the arrangement, the alignment of high accuracy is achieved. Then, when the alignment process of a specified number of sheets has completed, the sheet clamp member 412 is closed by this clamp solenoid 434 to hold the sheet bundle.

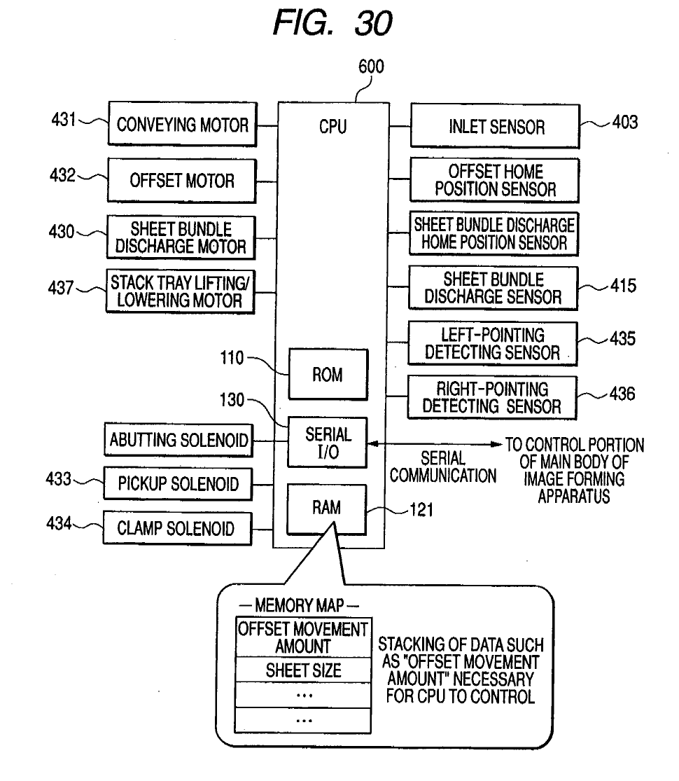

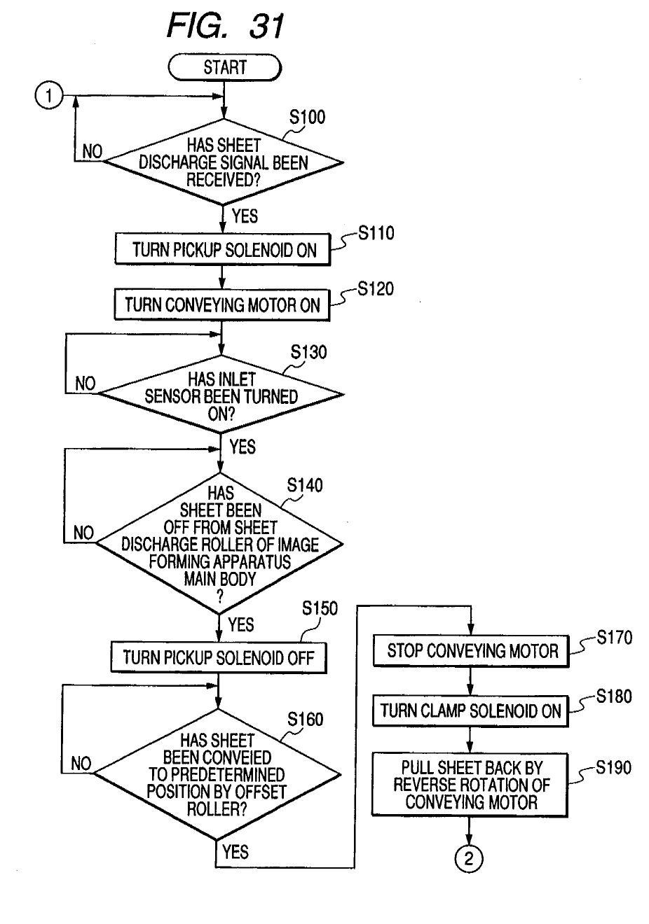

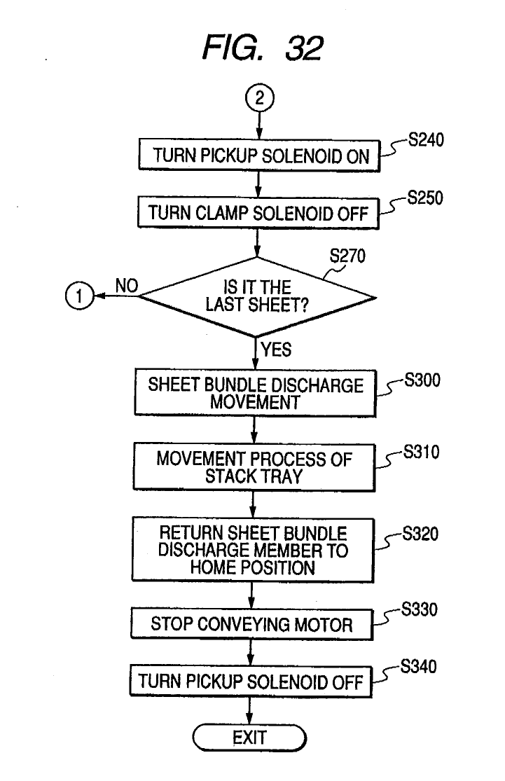

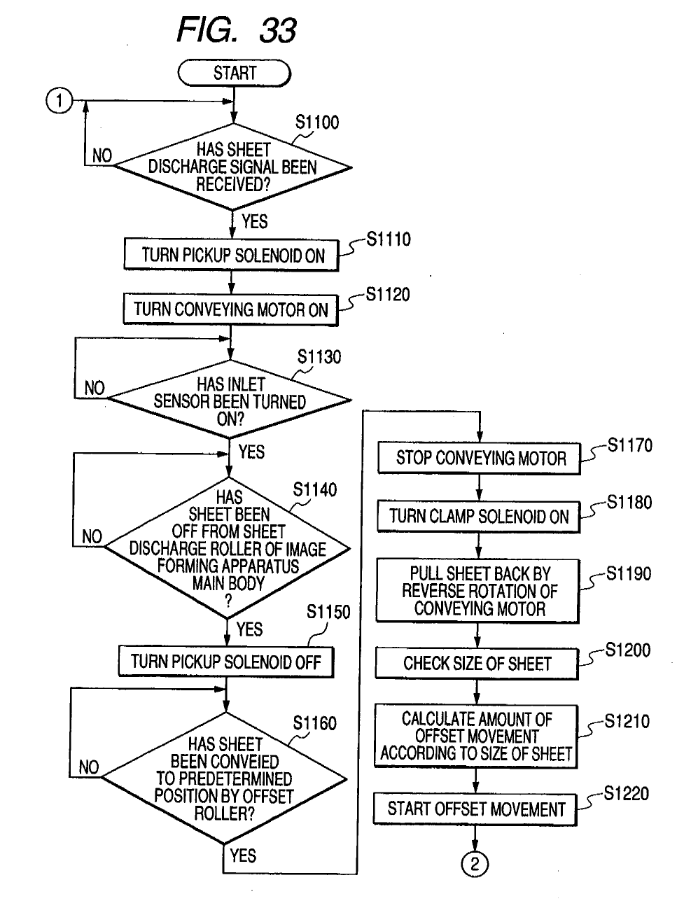

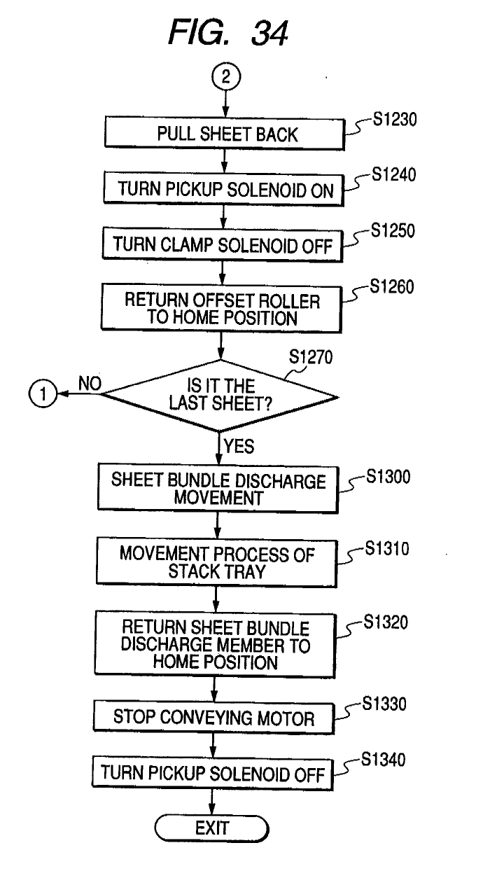

FIG. 30 is a control block diagram of the sheet processing apparatus 400. A CPU 600 includes a ROM 110 inside, and makes a control of each portion while reading out a control program corresponding to an operation procedure shown in the below-described flowcharts in FIGS. 31 to 34 stored in the ROM 110.

In addition, the CPU 600 contains therein a RAM 121 storing a working data and an input data, and the CPU 600 makes a control based on the data stored in the RAM 121. In addition, to an input port of the CPU 600, sensors such as the left-pointing detecting sensor 435 and the right-pointing detecting sensor 436 are connected. The CPU 600, based on the state of these sensors, makes a control of loads such as the conveying motor connected to an output port according to the program corresponding to an operation procedure illustrated in the flowcharts in FIGS. 31 to 34 stored in the ROM 110.

The CPU 600 is provided with a serial interface portion (I/O) 130, and makes a transmission and reception of a control data with the control portion 345, 346 of the main body 501A, 502A of the image forming apparatus.

Incidentally, the control portion 345, 346 of the main body 501A, 502A of the image forming apparatus grasps the size of a sheet to be discharged from the sheet discharge portion 208 (FIGS. 16 and 18). Therefore, the CPU 600 of the sheet processing apparatus 400 can grasp the size of the sheet having been discharged onto the processing tray 410.

Accordingly, the CPU 600 of the sheet processing apparatus 400, every time the sheet S is discharged from the main body 501A, 502A of the image forming apparatus, grasps the size thereof to control the offset motor 432, thus enabling to control the movement amount in the width direction of the offset roller 407. With the arrangement, the offset roller 407 can move by the amount according to the size of the sheet S discharged onto the processing tray 410, and can cause the side edge of the sheet to be reliably in contact with the positioning wall 416.

Incidentally, in this embodiment, due to that a sheet bundle stacked on the stack tray 421, 422 forms a part of the processing tray 410, when the sheet bundle SA is discharged from the processing tray 410, the stack tray 421, 422 is lowered by a stack tray lifting/lowering motor 437 (FIG. 30) until the uppermost surface of the sheet bundle stacked on the stack tray 421, 422 substantially coincides with the processing tray 410.

Now, a sheet processing operation of the sheet processing apparatus 400 will be described based on schematic views of FIGS. 16 to 29B, the control block diagram of FIG. 30 and the flowcharts of FIGS. 31 to 34.

The operation of the sheet processing apparatus 400 in the case where the sheet processing apparatus 400 is mounted in the opening region 501B of the image forming apparatus 501 according to the first embodiment of discharging the sheet from right to left as illustrated in FIG. 16 will be described. Descriptions will be made mainly based on FIGS. 23A, 23B, 31 and 32.

In the sheet processing apparatus 400, in the case of being mounted in the opening region 501B of the image forming apparatus 501 according to the first embodiment of discharging the sheet from right to left as illustrated in FIG. 16, the sheet is discharged at the central portion in the width direction not to be moved to the positioning wall 416.

First, when an image forming operation is started at the main body 501A of the image forming apparatus, the CPU 600 of the sheet processing apparatus 400 (FIG. 30) checks whether or not a sheet discharge signal to be notified from the main body of the image forming apparatus has been received (S100). Here, the CPU 600, in the case where the sheet discharge signal has been received (YES in S100), turns on the pickup solenoid 433 (S110). Then, the offset roller holder 406 is pivoted to be lifted, and thus the offset roller 407 is lifted.

Subsequently, the CPU 600 turns on the conveying motor 431 (FIGS. 22 and 30) (S120), the conveying roller 405 disposed on the way of a sheet discharge path (FIG. 16) is brought into rotation in the direction in which a sheet can be conveyed in the same direction as the sheet discharge direction of the main body 501A of the image forming apparatus. Here, the first sheet turns on the inlet sensor 403 (YES in S130). Thereafter, when the sheet has reached the conveying roller 405, the conveying roller 405 continuously conveys the sheet from the sheet discharge portion 208 (FIG. 16) of the main body 501A of the image forming apparatus (YES in S140).

Next, the CPU 600, while the sheet is being conveyed to the processing tray 410 by the conveying roller 405, turns off the pickup solenoid 433 just before the sheet has passed the conveying roller 405 (S150). Then, the offset roller 407 lands on the sheet with the aid of the gravitational force of the offset roller 407. Thereafter, the sheet S is conveyed to a predetermined position by the offset roller 407 (S160). Then, the CPU 600, when the sheet S has been conveyed to the predetermined position (YES in S160), stops rotation of the conveying motor 431 (S170) The sheet S stops.

Subsequently, the CPU 600 turns on the clamp solenoid 434 at a time point when the offset roller 407 is stopped to rotate (S180). Then, the sheet clamp member 412 disposed in the home position in the vicinity of the trailing edge stopper 411 is opened. Thereafter, the CPU 600 causes the conveying motor 431 to rotate in the opposite direction to the conveying direction to pull the sheet S back by the offset roller 407 (S190). The sheet is abutted on the trailing edge stopper 411 at the trailing edge (upstream edge).

Incidentally, the offset roller 407, to eliminate the skew feed of the sheet S that occurs when being fed from the main body 501A of the image forming apparatus, continues the reverse rotation for a predetermined time period since the sheet S is brought into contact with the trailing edge stopper 411.

With the arrangement, the sheet S can be reliably contacted with the trailing edge stopper 411. Incidentally, the offset roller 407 is adapted to be idled (slipped) on the sheet when the sheet S has been contacted with the trailing edge stopper 411, and the offset roller 407 continues the reverse rotation.

Next, when the alignment of the first sheet S has completed, the CPU 600 turns on the pickup solenoid 433 (S240), to lift the offset roller 407 as shown in FIG. 23A, and to turn off the clamp solenoid 434 (S250). Whereby, as shown in FIG. 23B, the sheet clamp member 412 is closed, and the sheet S having been aligned already is pinched and held by the sheet clamp member 412. As a result, the sheet S having been discharged first is prevented from being fed in association with the feed of a subsequent sheet to be discharged.

Then, the CPU 600 checks whether or not the sheet S stacked on this processing tray 410 is the last sheet corresponding to a final page of documents to be copied (S270). When it is determined not to be the last sheet S based on information having been transmitted from the main body 501A of the image forming apparatus (NO in S270), the CPU 600 returns to the process S100, and checks whether or not the sheet discharge signal to be notified from the main body 501A has been received. In such a way, the CPU 600 repeats the above-described flow until the last sheet S is contained on the processing tray 410.

On the other hand, when it is determined by the CPU 600 to be the last sheet in the process S270, a bundle of sheets corresponding to the copy documents is formed on the processing tray 410. In this case, the sheet bundle discharge member 413 shown in FIGS. 26A, 26B and 27 causes the sheet clamp member 412 to grab the sheet bundle SA to go ahead toward the stack tray 421, and thus to discharge the sheet bundle onto the stack tray 421 by the sheet bundle discharge motor 430 (S300).

Subsequently, the CPU 600 moves (lowers) the stack tray 421 in accordance with the discharge operation of the sheet bundle SA (S310), and thereafter returns the sheet bundle discharge member 413 to the home position (S320). Then, the CPU 600 stops the conveying motor 431 to stop the rotation of the conveying roller 405 and the offset roller 407 (S330). Finally, the CPU 600 turns off the pickup solenoid 433 (S340), and lowers the offset roller 407 to end a series of processing.

The sheet processing apparatus 400, in the case of being mounted in the opening region 501B of the image forming apparatus 501 of discharging the sheet from right to left, is arranged such that the sheet is discharged at the central portion in the width direction, and the sheet bundle is aligned at the trailing edge and thereafter discharged as it is by the sheet clamp member 412.

Therefore, the sheet bundle SA is not discharged on the back side of the opening region 501B of the image forming apparatus 501, but discharged in the position where a user can easily access (easily take out) the sheet bundle SA.

Now, the operation of the sheet processing apparatus 400 in the case of being mounted in the opening region 502B of the image forming apparatus 502 according to the second embodiment of discharging the sheet from left to right as illustrated in FIG. 18 will be described. Descriptions will be provided mainly in conjunction with FIGS. 24A, 24B, 24C, 25A, 25B, 33 and 34.

In the sheet processing apparatus 400, in the case of being mounted in the opening region 502B of the image forming apparatus 502 according to the second embodiment of discharging the sheet from right to left as illustrated in FIG. 18, the sheet is discharged at the central portion in the width direction, and moved to the positioning wall 416 on the front side apart from the back side. Therefore, as illustrated in FIG. 17, the sheet bundle SA is not discharged on the back side in the opening region of the image forming apparatus, but is discharged on the front side where a user easily access (easily take out) the sheet bundle SA.

First, when an image forming operation is started at the main body 502A of the image forming apparatus, the CPU 600 of the sheet processing apparatus 400 (refer to FIG. 30) checks whether or not a sheet discharge signal to be notified from the main body of the image forming apparatus has been received (S110). Here, the CPU 600, when received the sheet discharge signal (YES in S1100), turns on the pickup solenoid 433 (S1110). Then, the offset roller holder 406 pivots to be lifted, and thus the offset roller 407 is lifted.

Subsequently, the CPU 600 turns on the conveying motor 431 (FIGS. 22 and 30) (S1120), and rotates the conveying roller 405 (FIG. 18) disposed on the way of a sheet discharge path in the direction in which a sheet can be conveyed in the same direction as the sheet discharge direction of the main body 502A of the image forming apparatus. Here, the first sheet turns on the inlet sensor 403 (YES in S1130). Thereafter, when the sheet has reached the conveying roller 405, the conveying roller 405 continuously conveys the sheet from the sheet discharge portion 208 (FIG. 18) of the main body 502A of the image forming apparatus (YES in S1140).

Next, the CPU 600, while the sheet is being conveyed to the processing tray 410 by the conveying roller 405, turns off the pickup solenoid 433 just before the sheet has passed the conveying roller 405 (S1150). Then, the offset roller 407 lands on the sheet with the aid of the gravitational force of the offset roller 407. Thereafter, as shown in FIG. 24A, the sheet S is conveyed to a predetermined position by the offset roller 407 (S1160). Then, the CPU 600, when the sheet S has been conveyed to the predetermined position (YES in S1160), stops rotation of the conveying motor 431 (S1170). The sheet S stops.

Subsequently, the CPU 600 turns on the clamp solenoid 434 at a time point when the rotation of the offset roller 407 is stopped (S1180). Then, as shown in FIG. 24B, the sheet clamp member 412 disposed in the home position in the vicinity of the trailing edge stopper 411 is opened. Thereafter, the CPU 600 causes the conveying motor 431 to rotate in the opposite direction to the conveying direction to pull the sheet S back by the offset roller 407 (S1190). The sheet is abutted on the trailing edge stopper 411 at the trailing edge (upstream edge).

Next, the CPU 600 checks the size of the sheet to be discharged with size information from the main body 502A of the image forming apparatus (S1200), and calculates the amount of an offset movement of the offset roller 407 according to the size of the sheet S to be discharged (S1210). That is, the CPU 600 calculates the amount of the offset movement, being a movement amount in the width direction of the sheet S necessary for pressing the sheet having been discharged onto the processing tray 410 against the positioning wall 416 (S1210).

Then, the CPU 600 drives the offset motor 432, and starts the offset movement of the offset roller 407 (S1220). Here, on the occasion when the offset roller 407 is moved in such a manner, the sheet S in contact with the offset roller 407 is moved along with the offset roller 407 toward the positioning wall 416 by a frictional force provided by the offset roller 407. Incidentally, at this time, the sheet clamp member 412, as shown in FIG. 24C, is pivoted upward so as not to be the load for the movement of the sheet S.

Thus, by such offset movement operation of the offset roller 407, as shown in FIG. 24C, the sheet is abutted on the positioning wall 416, whereby the alignment in the width direction of the sheet S is conducted. Incidentally, in FIGS. 24B and 24C, when the offset roller holder 406 is moved to the left, although it appears to interfere with the sheet clamp member 412, actually, they are in a layout relationship of not being interfered each other. The offset roller 407, after having abutted the sheet S on the positioning wall 416, is moved while being slid to some extent on the sheet S to be stopped. Thereafter, the CPU 600, to correct the misalignment in the conveying direction after the offset movement, makes an alignment of causing the offset roller 407 to rotate reversely again to pull the sheet S back (S1230), whereby the alignment of the first sheet S has completed.

Next, the CPU 600, when the alignment of the first sheet S has completed, turns on the pickup solenoid 433 (S1240) to lift the offset roller 407 as shown in FIG. 25A, and turns off the clamp solenoid 434 (S1250). Whereby, as shown in FIG. 25B, the sheet clamp member 412 is closed, and the sheet S having been aligned is pinched and held by the sheet clamp member 412. As a result, the sheet S having been discharged first can be prevented from being fed in association with the feed of a sheet to be discharged next.

Then, as shown in FIG. 25B, the offset roller 407 is moved and returned to the home position with a rack and a pinion while being lifted by the offset motor 432 (S1260).

Subsequently, the CPU 600 checks whether or not the sheet stacked on this processing tray 410 is the last sheet corresponding to the last page of documents to be copied (S1270). The CPU 600, in the case where it is determined not to be the last sheet S based on information having been transmitted from the main body 502A of the image forming apparatus (NO in S1270), returns to the process S1100, and then checks the sheet discharge signal to be transmitted from the main body 502A. With the arrangement, the CPU 600 repeats the above-described flow until the last sheet S is contained on the processing tray 410.

On the other hand, when the CPU 600 determines that it is the last sheet in the process S1270, the bundle of sheets corresponding to the documents to be copied is formed on the processing tray 410. In this case, the sheet bundle discharge member 413 shown in FIGS. 26A, 26B and 27 causes the sheet clamp member 412 to grab the sheet bundle SA to go ahead toward the stack tray 421, and thus to discharge the sheet bundle SA onto the stack tray 421 by the sheet bundle discharge motor 430 (S1300).

Subsequently, the CPU 600 moves (lowers) the stack tray 421 in accordance with the discharge operation of the sheet bundle SA (S1310), and thereafter returns the sheet bundle discharge member 413 to the home position (S1320). Then, the CPU 600 stops the conveying motor 431 to stop the rotation of the conveying roller 405 and the offset roller 407 (S1330). Finally, the CPU 600 turns off the pickup solenoid 433 (S1340) and lowers the offset roller 407 to end a series of processing.

In the above-described sheet processing apparatus 400, the offset roller 407 causes the sheet stacked on the processing tray 410 to position at the central portion or on the front side in the sheet width direction based on a detecting operation of the left-pointing and the right-pointing detecting sensors 435 and 436 (FIGS. 17 and 19). That is, the sheet is positioned on the front side apart from the back side. Therefore, depending on whether the apparatus in which the sheet processing apparatus is mounted is the image forming apparatus 501 according to the first embodiment or the image forming apparatus 502 according to the second embodiment, the sheet can be positioned at the central portion or on the front side. Thus, in the sheet processing apparatus 400, visibility is not impaired by an upper portion (reader portion 120, the ADF 300) of the opening region 501B, 502B of the image forming apparatus in which the image forming apparatus 400 is mounted, thus making it easy for a user to take out the sheet.

In the above descriptions, although the position changing unit moving the sheet in the width direction includes the offset roller 307, 407 and the offset motor 332, 432, the position changing unit may include a mechanism moving the sheet in the sheet conveying direction and a mechanism moving this mechanism to move in the sheet width direction.

In addition, in this embodiment, supposed is the case where a sheet processing apparatus is mounted in an image forming apparatus of in-body sheet-discharge type in which an image reading portion is located at the upper portion of the main body of the image forming apparatus, and a sheet is discharged from a discharge unit below this image reading portion. Even if, however, the sheet processing apparatus is connected to an image forming apparatus of type in which there is no image reading portion at the upper portion of the main body of the image forming apparatus, the same advantage can be obtained.

Furthermore, in this embodiment, a control is made while the program written on the ROM (or RAM) is being read out by the CPU. Even if, however, processing on the control program is configured to be executed by hardware, the same advantage can be obtained.

Moreover, the sheet processing apparatus 301, 400, although operated by the control of the CPU 100, 600, may be controlled by the control portion 345, 346 provided at the main body of the image forming apparatus.

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Application No. 2006-347447 filed Dec. 25, 2006, which is hereby incorporated by reference herein in its entirety.

What is claimed is:

1. A sheet processing apparatus to be mounted in an opening region of an image forming apparatus, which forms an image on a sheet to discharge the sheet into the opening region of a main body of the image forming apparatus, the sheet processing apparatus comprising:
a sheet stacking unit on which the sheet having been discharged into the opening region is stacked; and
a position changing unit causing the sheet to position on a front side apart from a back side of the sheet stacking unit based on type information of the image forming apparatus.

2. A sheet processing apparatus according to claim 1, wherein the type information includes information indicating that the image forming apparatus in which the sheet processing apparatus is mounted is a first image forming apparatus for discharging the sheet into the opening region from right to left, and information indicating that the image forming apparatus in which the sheet processing apparatus is mounted is a second image forming apparatus for discharging the sheet into the opening region from left to right, and
wherein the sheet processing apparatus further comprises a discrimination unit, which discriminates whether the image forming apparatus in which the sheet processing apparatus is mounted is the first image forming apparatus or the second image forming apparatus by detecting a wall provided on the back side in the opening region of the image forming apparatus in which the sheet processing apparatus is mounted, and outputs the type information.

3. An image forming apparatus comprising:
an image reading unit reading a document;
an image forming unit, which is disposed below the image reading unit, and which forms an image on a sheet based on image information of the document having been read by the image reading unit; and
a sheet processing apparatus mounted in an opening region between the image reading unit and the image forming unit, the sheet processing apparatus including;
a sheet stacking unit on which the sheet on which the image has been formed by the image forming unit is stacked; and
a position changing unit causing the sheet to position on a front side apart from a back side of the sheet stacking unit based on type information of the image forming apparatus.

4. An image forming apparatus according to claim 3, wherein the type information includes information indicating that the image forming apparatus in which the sheet processing apparatus is mounted is a first image forming apparatus for discharging the sheet into the opening region from right to left, and information indicating that the image forming apparatus in which the sheet processing apparatus is mounted is a second image forming apparatus for discharging the sheet into the opening region from left to right, and
wherein the image forming apparatus further comprises a discrimination unit, which discriminates whether the image forming apparatus in which the sheet processing apparatus is mounted is the first image forming apparatus or the second image forming apparatus by detecting a wall provided on the back side in the opening region of the image forming apparatus in which the sheet processing apparatus is mounted, and outputs the type information.

5. An image forming apparatus according to claim 3, wherein the type information includes information indicating that the image forming apparatus in which the sheet processing apparatus is mounted is a first image forming apparatus for discharging the sheet into the opening region from right to left, and information indicating that the image forming apparatus in which the sheet processing apparatus is mounted is a second image forming apparatus of discharging the sheet into the opening region from left to right; and
wherein the image forming apparatus further comprises a discrimination unit, which is disposed between a main body of the image forming apparatus and the sheet processing apparatus, discriminates whether the image forming apparatus in which the sheet processing apparatus is mounted is the first image forming apparatus or the second image forming apparatus, and outputs the type information.

6. An image forming apparatus according to claim 3, wherein the type information includes information indicating that the image forming apparatus in which the sheet processing apparatus is mounted is a first image forming apparatus for discharging the sheet into the opening region from right to left, and information indicating that the image forming apparatus in which the sheet processing apparatus is mounted is a second image forming apparatus for discharging the sheet into the opening region from left to right, and
wherein the image forming apparatus further comprises a notifying unit, which notifies, as the type information, information of whether the image forming apparatus in which the sheet processing apparatus is mounted is the first image forming apparatus or the second image forming apparatus.
